(19) United States
(12) Patent Application Publication
(10) Pub. No.: US 2010/0241698 A1
(43) Pub. Date: Sep. 23, 2010

(54) METHODS AND SYSTEMS FOR AUTO-GENERATING MODELS OF NETWORKS FOR NETWORK MANAGEMENT PURPOSES

(75) Inventor: Eric Thomas Hillerbrand, Wilmette, IL (US)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: TALK3, INC., Northfield, IL (US)

(21) Appl. No.: 12/726,460

(22) Filed: Mar. 18, 2010

Related U.S. Application Data
(60) Provisional application No. 61/161,405, filed on Mar. 18, 2009.

(51) Int. Cl. G06F 15/173; G06F 15/16; G06F 17/30

(52) U.S. Cl. 709/203; 709/223; 707/813

(57) ABSTRACT

A system and method for modeling networks by auto-generation. The system generally comprises methods and systems for enabling the extraction, management and merging of models of networks and creating models of networks that can dynamically respond to changing context and computer requirements. The method includes ways of creating network models, maintaining n-dimensional graphs of networks; using adaptive and evolutionary algorithms for result emergence, using training and feedback to tune adaptive algorithms for solution optimization, and transformation of results into ontological and or data models.

### CROSS REFERENCE TO RELATED APPLICATIONS

This application claims priority to U.S. Provisional Patent Application No. 61/161,405, filed Mar. 18, 2009, the entire contents of which are incorporated by reference, as if fully set forth herein.

### FIELD OF THE INVENTION

This present invention relates generally to computer-implemented systems and methods for modeling the form and function of networks that consist of network resources such as human, information, computer, and process systems. More particularly, the present invention relates to systems and methods for enabling the extraction, management and merging of models of networks, and creating models of networks that can dynamically respond to changing context and computer requirements.

### BACKGROUND OF THE INVENTION

In the increasingly heterogeneous Internet environment pressure is being placed on managing the interplay of networks of people (e.g., the Facebook® community), networks of processes or functions (e.g., a network that performs a function which could include a computer system with distributed data or computational services or a social network engaged in a specific activity or function such as Mint®) and networks of content (e.g., a published of online ecommcrce content such as online coupons, fliers, or advertising) both within established or free-forming networks of interactions, or across and between such networks. A network may be defined as a set of resources such as computer hardware, computer software, people, policies, procedures and processes such as transactions (i.e., commerce) or information flows operating together as a whole system under regulated conditions. The process of management is fundamentally distinct from traditional system interoperability or integration activities. In the traditional process, the intent is to connect two systems together through either a proprietary or open API, capturing system level events, and then using predetermined events create inter-system messages that are captured, transformed and routed based on some process logic. For example, a traditional process of integrating two online datastores (e.g., weather data store and address data store for the purposes of finding weather at a specific address) involves access the data stores through an interface and then taking the data structure (i.e., type of weather and longitude/latitude location) and mapping that, typically by hand, to the other data store (i.e., zip code and address) using some computational transformation (i.e., this longitude/latitude is the same as this address).

In the Internet environment, traditional systems-level integration, which might be considered a single dimensional activity, is no longer adequate. Instead, the interplay between persons, commerce, process, and content within specific contexts creates the requirement for a robust n dimensional model to support these multiple dimensions.

Further, the dynamism of network evolution, whether social, system, or procedural networks, rejects static, uni-dimensional, context-free integration activities. Human interaction is innately messy. Despite occasional trappings of formality, the underlying behavior frequently borders on the chaotic. As a result, established business and social processes tend to morph and evolve over time. Dialogs are often incomplete. True intent is often veiled and the real nature of the underlying relationship is elusive. This does not imply that human behavior is necessarily evil, but rather, it overstates the obvious. Human networking and processes are not a deterministic phenomenon.

Human activity does not conform to neat data models, knowledge representations, or ontological structures. It defies categorization and classification typically associated with data mining. It exceeds the limitations of natural language processing. Rather human behavioral interaction patterns represent the type of complexity discovered throughout the natural world. Just as bees and ants cooperate to form functional colonies, humans cluster into far more complex but equally productive social structures. Just as the human-spawned Internet creates small world phenomena, human relationships also exhibit the same attributes. Even the architecture of the human body mimics the complex evolutionary architectures repeated throughout nature. In short, human behavior and the very human structure are both governed by the natural laws stemming from the study of complex behaviors.

Complexity or chaos, relatively new and highly profound concepts, challenge existing notions of our universe. Complexity works in harmony with the accepted principles of the hard sciences such as physics, chemistry and biology. It also extends deeply into the social sciences. The study of complexity continues to both reinforce and unify these heretofore separate disciplines. It is a far reaching concept which permits observation of non-deterministic behavior with predictable results. This is significant when it comes to understanding and interpreting human interaction.

Complexity plays out in the marketplace. It is present in international politics and underlies the emergent “global village”. It is definitely at play in the international war on terror. It simply cannot be overlooked. At the same time, complexity is contrary to the way we have been accustomed to managing computation. Based upon binary realities, computer science has grown up in a deterministic world where precision reigned supreme. In indirect recognition of complexity, however, the ascent of the Internet, biological computing, and more recently Web 2.0 social networks, begin to move computational behavior away from precision computing. These phenomena open the door to more natural networks. In essence, computation is adapting to reflect and reinforce the world wide society that produced it.

Thus, to effectively measure or classify human behavior, manage the interactions of process, information sharing, and commerce, assess relationships and ascribe motivation, complex behavioral patterns must come into play. Ironically, up to this point, these models have largely been seen as subsumable in the application of semantics, a natural offshoot of human networking behavior. Ontological modeling, semantic definition, and Web 3.0 or Semantic Web applications cannot quantify this level of complexity.

Semantics, however, are inherently impossible to define through rule based approaches such as natural language processing or grammar-based parsers. There is far too much nuance, contextual definition, and idiom for a system using these traditional approaches to scale. Eventually an army of knowledge engineers, ontologists, and minders of taxonomies and controlled vocabularies, must be mustered to support those rules. Even then, recent experience shows a phalanx of knowledge workers just cannot keep track of all the specialized rules for unique circumstances and innumerable exceptions. This problem redoubles in the burgeoning world of service oriented architectures as new services and their rule sets proliferate unabated. Semantics are really applied complexity. Despite ongoing herculean efforts to do so, they too cannot be managed deterministically.

Take, for example, a paragraph of words which may be parsed with a grammar-based parser such as an English dictionary. The problem with such a method is that the dictionary can only provide a single definition for each term in each sentence in the paragraph. Often times, single words have different meanings in different settings, and may also have different meanings to different groups of people. If one of the sentences was “the red fox runs fast,” such a statement may have different meanings when read by different groups. The sentence may be read one way in the context of a war movie, and differently in a children's book. Accordingly, the ability to provide context becomes paramount. The importance of context has long been considered a critical part of semantic theory.

The traditional process of building architectures and their associated ontologies and taxonomies requires labor intensive analysis at the detail level. Typically, this costly manual process yields static products, often outdated at the moment of their creation. While such products serve to meet existing reporting and compliance requirements, they contribute very little to real operational or system design issues.

The traditional process also frequently operates under the implicit assumption that there must be a single correct answer. This assumption discounts the myriad of real-world variables which contribute to practical contextual variation. In reality, the correct answer is dependent on the specific context and the relevant use cases can be extensive and dynamic in their own right.

The path to better Internet software is thought to be merely a case of generating new algorithms or tweaking old ones, whether behavioral targeting, neural networks, collaborative filtering, data mining or thousands of other names for algorithms to achieve data fusion. Those approaches are all wrong for today's Internet because these algorithms and Statistical approaches assume determinism—a specific correct solution, that applies across the board and in all cases.

Rather, networking modeling must be viewed not as a semantic definition problem but as a living example of emergent complexity. The world is complex and beyond the capability of human definition, and thus the chaos, garbage and noise associated with any organized or relatively disorganized network behavior should be embraced. By accepting all the artifacts of network interaction, human or system, the resulting pattern better reflects the actual interactions and reveal the underlying natural patterns in otherwise imperceptible ways.

As discussed above, conventional network modeling techniques do not allow for contextual definitions. Thus, the use of such modeling techniques is limited with respect to the current manner in which the Internet is evolving.

Accordingly, there is presently a need for a system and method for generating network models which takes context into account, which may be generated organically through information already existing on the Internet, and which utilizes complexity and emergence as the predominant dynamics of the underlying system architecture.

### SUMMARY OF THE INVENTION

An exemplary embodiment of the present invention comprises a computer system including at least one server computer and at least one client computer coupled to the at least one server computer through a network, wherein the at least one server computer includes at least one program stored thereon, the at least one program being capable of performing the steps of processing information relating to at least one network, establishing at least one relationship between the processed information and information contained in a first datastore, establishing the degree to which the processed information and the at least one relationship conform to at least one predetermined pattern, and forming a network model based on the at least one relationship and the at least one predetermined pattern.

An exemplary embodiment of the present invention also comprises a computer system for auto-generation of network models including a processing component, an affinity generation component, an adaptation manager, and a datastore.

An exemplary embodiment of the present invention also comprises a computer readable medium having embodied therein a computer program for processing by a machine, the computer program including a first code segment for processing information relating to at least one network, a second code segment for establishing at least one relationship between the processed information and information contained in a first datastore, a third code segment for establishing the degree to which the processed information and the at least one relationship conform to at least one predetermined pattern, and a fourth code segment for forming a network model based on the at least one relationship and the at least one predetermined pattern.

### BRIEF DESCRIPTION OF THE DRAWINGS

The invention will be better understood with reference to the following detailed description, of which the following drawings form an integral part.

FIG. 1 is a schematic diagram of a computer system according to an exemplary embodiment of the present invention.

FIG. 2 is a flow diagram of an exemplary method performed by the garbage eater component shown in FIG. 1.

FIG. 3 is a flow diagram of an exemplary method performed by the affinity generation component shown in FIG. 1.

FIG. 4 is a flow diagram of an exemplary method performed by the adaptation manager component shown in FIG. 1.

FIG. 5 is a flow diagram of an exemplary method for creating associations between tokens shown in FIG. 1.

FIG. 6 is a schematic diagram showing further details of the adaptation manager component shown in FIG. 1.

FIG. 7 is a flow diagram illustrating in greater detail the steps that occur with regard to affinity generation component shown in FIG. 1.

FIG. 8 is a flow diagram illustrating in greater detail the steps for algorithm composition and hierarchy creation.

FIG. 9 is a flow diagram illustrating in greater detail than FIG. 8 that further associations can be defined between graphs of algorithms and graphs of tokens.

FIG. 10 is a flow diagram illustrating in greater detail than FIG. 8 n-dimensional graphs, and in particular, the associations of graphs of algorithms and graphs of tokens across multiple dimensions.

FIG. 11 is a flow diagram illustrating in greater detail than FIG. 8 illustrating n-dimensional graphs within a specific context, and in particular, the associations of graphs of algorithms and graphs of tokens across multiple dimensions for a given context.

FIG. 12 is a flow diagram illustrating in greater detail than FIG. 8 illustrating n-dimensional graphs within a specific context across multiple dimensions, and in particular, a graph of associations of algorithms and tokens across multiple dimensions within a context evolved and adapted over time.

FIG. 13 is a flow diagram illustrating in greater detail than FIG. 8 illustrating n-dimensional graphs with emergent associations occurring across time, and in particular, that further associations can be defined between graphs of algorithms and graphs of tokens.

FIG. 14 is a flow diagram illustrating in greater detail than FIG. 8 illustrating n-dimensional graphs with changing weights occurring across time, and in particular, that further associations can be defined between graphs of algorithms and graphs of tokens.

FIG. 15 is a block diagram of a simplified auto-generation system, which corresponds to the auto-generation system shown in FIG. 1.

FIG. 16 is a block diagram of a detailed auto-generation system, which corresponds to the auto-generation system shown in FIG. 1.

FIG. 17 is a block diagram of a detailed auto-generation system, which corresponds to the auto-generation system shown in FIG. 1, showing communication flow lines.

FIG. 18 is a schematic diagram of components of the datastore shown in FIG. 1.

FIG. 19 is a block diagram illustrating a simplified, exemplary operating environment.

FIG. 20 is a block diagram illustrating a simplified, exemplary operating environment that is accessible through a system API.

FIG. 21 is a schematic diagram of an ecosource system.

FIG. 22 is a detail view of the schematic shown in FIG. 21 illustrating an exemplary neuro-cognitive model defining a specific theory of affinity and corresponding algorithms.

FIG. 23 is a detail view of the schematic shown in FIG. 21 showing the resultant relationships and weights between the exemplary model and a specific set of classifiers resulting in a classifier hierarchy.

FIG. 24 is a flow diagram describing the flow of operations for the system shown in FIG. 1.

FIG. 25 is a schematic diagram of the enablement of a business ecosystem encompassing a ‘network of networks,’ and the network interactions to support a co-marketing activity as an exemplary embodiment of the present invention.

FIG. 26 is a detail view of the schematic shown in FIG. 25 showing the flow of operations as an exemplary embodiment of the present invention to support the business operations defined in FIG. 25.

FIG. 27 is a detail view of the schematic shown in FIG. 25 showing n-dimensional graphs illustrating a combined network of people, products and content.

FIG. 28 is a detail view of the schematic shown in FIG. 25 showing n-dimensional graphs and corresponding dimensions X, Y, Z bisecting the combined graph.

FIG. 29 is an illustrative example of the schematic shown in FIG. 25 showing the integration of social networks from three different social network Internet sites and the corresponding user profiles of two members in each network.

FIG. 30 is a detail view of the illustration shown in FIG. 29 showing the interrelationships of the content graphs as evident in each of the social networks.

FIG. 31 is a detail view of the schematic shown in FIG. 29 showing the across memberships across the three social networks.

FIG. 32 is a detail view of the illustration shown in FIG. 29 showing the cross authorship of content across the three social networks.

FIG. 33 is a detail view of the illustration shown in FIG. 29 showing the latent social network that exists across the three networks based on a specific dimension or dimensions that integrates the content across the three social networks.

FIG. 34 is a detail view of the illustration shown in FIG. 29 illustrating the thematic associations and multi-dimensions that define the interrelationships across the three social networks.

FIG. 35 is a detail view of the illustration shown in FIG. 29 showing the multi-dimensional relationships that integrate across the three social networks.

FIG. 36 is a block diagram of an illustrative example of the schematic shown in FIG. 25 in which a vendor and two social networks are integrating content across networks in order to profile consumers and deliver marketing communication.

FIG. 37 is a block diagram further illustrating the example in FIG. 36 and demonstrating multiple vendors involved in this marketing ecosystem.

FIG. 38 is a block diagram illustrating the communication interface to the computer system shown in FIG. 1.

FIG. 39 is a schematic diagram of a user interface associated with the computer system shown in FIG. 1.

### DETAILED DESCRIPTION

### Background

The present invention acknowledges the world of complex behavior and harnesses that very complexity to better understand and manage networks. In so doing, a computational neuroscience approach is adopted pioneering a natural way to cultivate network models, termed ‘knowledge eco-systems’. This computational neuroscience approach incorporates dynamics of complexity, connectionism, and emergence. A processed network, represented as a graph of nodes, operates analogously to theories of neuro-cognitive processing. Connections of varying weights are established between the nodes of the graph. A specific cognitive process may thus be represented by n number of connection paths between nodes. All connection paths compete to provide the best optimization of the specific process, and the ‘best fit’ emerges based on the specific context and path constraints present at the time that the process is occurring.

Knowledge eco-systems, in turn, significantly streamline the tasks typically associated with the emergent discipline of knowledge engineering. The need to adhere to static ontologies and arbitrarily evolving standards becomes unnecessary when knowledge eco-systems adapt dynamically to naturally changing conditions. As complexity is all about dynamic adaptive behavior, any approach to precisely quantify that behavior is a frozen moment in time. Thus, static architectures must give rise to adaptive architectures that can accommodate rapidly changing conditions. Complexity suggests that emergent behavior is continuous and the ongoing adaptation must be managed accordingly.

However, semantics, a product of human thought, has been shown to exhibit complex behavior. Semantics are impossible to comprehend, but rather can be viewed as structural representations of evolving complex and chaotic phenomenon. This means that the components of any network interaction can be reduced to a set of relationships where lesser nodes are attracted to a small number of well connected hubs that serve to link and build connectedness among all data in a given domain. Thus, if one were to capture network interaction, reduce them to their affinities through their innate patterns and influence these patterns through application of context, one could effectively translate one message to another and output in that appropriate format.

The present invention is based on computational neuro-cognition. Computational neuro-cognition combines realities of biology, neurology, cognitive science, mathematics, and computer science. This approach looks at ways that binary computers can be harnessed to parallel the natural organization and function of the brain, in particular, cognition. Computational neuroscience holds to several principles:
1. Just like the brain uses multiple, differing and simultaneous pathways to achieve cognitive processing, computer architectures should adopt multiple, differing and simultaneous pathways to converge on workable solutions. While computers remain inherently binary in nature, current capacities permit such brain-like processing.
2. The brain connects neurons in many different ways where a given neuron may have greater or lesser value depending upon connectivity. Some connections are stronger in a particular context; others are weaker. Computer architectures should assume similar multiple and parallel ways of connecting information. This architecture should support continuous refinement of connection strengths through active feedback loops. Stronger connections should emerge and result in a stronger preference for a specific connection algorithm drawn from a sea of competing algorithms.
3. Human cognition is highly complex and has proven to be ill defined through the simple expression of rules. Internet software, to be congruent with cognition, should also be built based on a complex adaptive architecture. That means that rules are latently defined through feedback and exclusion. Implicit rules are well hidden within the use of exemplars, metaphors, analogies, and fuzzy inference. These variable and fleeting rules defy quantification.
4. Human cognition is emergent. That means that the humans understand meaning or think about something using a complex network of neural connections. Thinking consists of an almost random traversing of connections, in which neurons compete to create a cognitive process. In the computer world, processing in a particular context assumes high levels of complexity in which and the result is a synthesized best fit notion.

In the present invention architectural algorithms are conceptually treated as neuron connections. That means that rather than build a system on a specific algorithm or group of algorithms, the inventions presumes an infinite number of algorithms that are possible. Each algorithm or combinations of algorithms represents computationally a connected path of processing. Some algorithms or combinations are more powerful. But power, as is the case in neuro-cognition, is highly contextualized. An algorithm in one context may have extraordinary power while in another context provide little value. These algorithms, much like neuronal pathways, must compete at any instance for the greatest explanatory power.

At a micro level, neuron processing appears to be extremely complex, chaotic, and, at times, apparently random. New developments in network science have revealed that connected networks have patterns that are highly discernible at a macro level. These new developments, called a network's ‘scale-free’ properties finds that nodal attention is scale free in distribution, that nodes tend to cluster into small worlds, and there are certain dynamics with nodal attachment such as ‘preferential attachment’ and ‘randomization’ that dictate how nodal connections occur. Harnessing these findings from network science, one can uncover where these macro patterns exist within the network data structures.

Moreover, the same type of macro patterns are clearly what the fields of psychology, specifically cognitive science research has revealed. Cognitive scientists have been able to study the organizational structures of information in human memory for experiences and information at the macro level. Cognitive science has also been able to identify the implicit macro processing logic of information. In the present invention, information generated by users allows for the development of sophisticated networks, tying the networks together into ‘networks of networks,’ and creating opportunities for sophisticated models of meta-network interactions and highly targeted communications and recommendations. The invention exercises a number of sophisticated algorithms to build a highly scalable network of related small-world nodes that define true affinities among the elements of the body of knowledge. Authoritative classifiers inject contextual refinement at a macro level. Finally, powerful genetic algorithms, trained and bounded by Subject Matter Expert (SME) interaction, permit convergence on reliable use case based solutions.

Working with cognitive scientists, psychologists, and computer scientists, specific operant cognitive functions and processes can be identified. These functions and processes stem directly from applied psychological and cognitive science theory and research. Cognitive processes related to network interactions are foundational. Such cognitive processes as attraction, affiliation, affinity, influence, and attitude change, have been identified. These processes all flow from multiple and often competing theoretical and research findings. In keeping with neuro-cognitive mimicry, no effort is made in the present invention or exemplary implementations to single out or isolate a specific process as preferred.

The present invention can implement individual cognitive constructs. For example, contexts can be simply refined by use of appropriate keywords. In a more sophisticated approach, specialized classifiers can be created to place contextual boundaries on otherwise contextually unconstrained content. Finally, powerful genetic algorithms can be trained using standard construct validation techniques. The genetic algorithms both converge on workable solutions and create new contextually relevant classifiers. These solutions are weighted and often counterintuitive but nonetheless effective. Many cognitive constructs consist of compositions of multiple concepts. The idea of construct nesting is paralleled in the present invention. Once foundation cognitive constructs are implemented, higher order constructs may then be built up.

The present invention uses complexity and emergence to extract new configurations of cognitive constructs that define other constructs. The present invention uses various learning and genetic algorithms to create or form new classifiers. The resulting higher order construct genetic algorithms may then be trained by bounding to meet construct validity criteria. These classifiers define, in context, new combinations of psychological constructs that can relate directly to online information. The result: new cognitive constructs are created, comprising compositions of constructs, to explain relevant phenomenon.

Use of feedback mechanisms in the present invention creates the capability of evolutionary explanation. Over time, and with feedback, explanations of information, and therefore, understanding, increases. In essence, explanatory power is constantly improving.

### DESCRIPTION OF SPECIFIC EXEMPLARY EMBODIMENTS

The present invention relates generally to modeling the form and function of networks comprising networked resources such as human, information, computer, and process systems. The present invention provides systems and methods for enabling the extraction, management and merging models of networks and creating models of networks of network. This allows for automated generation of data models, knowledge representations, ontologies, and other descriptive models that support computer-interpretability. These models are exposed to computer systems through an application interface (API) or as a readable data model either in Bache mode or real time.

Computer-interpretability allows software applications to be created that perform: (i) automatic integration of disparate descriptions of network resources across disparate datastores and computer systems; (ii) automatic interpretability of network behavior; (iii) automatic computer process discovery that provides a particular process or information flow that adheres to requested network constraints; (iv) automatic process invocation through use of a machine understandable description of the process and information flow and how specific operations within the process are invoked; (v) automatic process generation and interoperation by describing interfaces and pre- and post conditions so as to allow software automatically to translate and transform between disparate processes based on a specific objective; (vi) automatic data integration to allow software automatically to translate and transform between disparate data based on a specific objective; (vii) automatic extraction of associations based on aggregate behavior of consumers which can include extraction from social media sites (i.e., typically called ‘crowdsourcing’): and (viii) automatic monitoring of context including events by describing process execution and critical events so that software monitor services that have disparate descriptions. Briefly described, the present invention comprises systems and methods for creating models of networks.

### First Exemplary Embodiment

A first exemplary embodiment of the present invention comprises a method including the steps of (a) processing descriptive information that is in a digital format and describes each network; (b) establishing relationships between the processed information and any other information in a computer system datastore; (c) establishing the degree the processed information and the relationships conform to some predetermined pattern; (d) establishing connection weights and other attributes based on the relationships and pattern match for each computational algorithm; (e) using computational algorithms for determining which executed algorithms' patterns best fit against some criteria; (f) providing feedback on the correctness or incorrectness of identified patterns and using learning algorithms for optimizing weights, relationships, and patterns; (g) executing computational algorithms against the processed information and their connections for the purposes of identifying relationships and patterns across and between network models; (h) executing computational algorithms for establishing the best fit of relationships and patterns for models of networks against some criteria; (i) providing feedback on the correctness or incorrectness of identified patterns and using learning algorithms for optimizing the weights, relationships, and patterns for a model of networks; and (j) whereby the resultant information and relationships conforming to the optimized pattern create an knowledge ecosystem.

The first exemplary embodiment of the present invention, it will be appreciated, involves a set of networks containing resources, and the cross and between network interactions and systems of interactions. In an exemplary embodiment of the present invention a network may comprise people, policies, procedures, computer systems and information, and the interrelationships. In an exemplary embodiment of the invention ecosystems comprise computer processable models that define explicit and latent entities, sets of those entities, their relationships, rules, and information and operational flows regarding, the entities and their relationships using description logic. In the present invention, an ecosystem may comprise a common operating picture of the operation of a ‘network of networks’. In an exemplary embodiment of the present invention descriptive information comprises digital information that is stored on a computer system. The processing of such descriptive information comprises tokenizing information by parsing the information based on one or more algorithms. Establishing connections between processed information establishes the proximity relationships between processed information and any other information in the system. Within the present invention, feedback comprises the use of training and learning algorithms.

### Second Exemplary Embodiment

A second exemplary embodiment of the present invention comprises method of computing to address a predetermined computing requirement for extracting, creating, and merging models of networks. This method comprises steps of (a) processing digital information for each network; (b) establishing the connections between the processed information and any other information in the system datastore based on one or more algorithms; (c) executing computational algorithms against the processed information and their connections for the purposes of identifying relationships and patterns; (d) executing computational algorithms for establishing the best lit of relationships and patterns against some criteria; (e) providing feedback on the correctness or incorrectness of identified patterns and using learning algorithms to reestablish the weights, relationships, and patterns; (f) executing computational algorithms against the processed information and their connections for the purposes of identifying relationships and patterns across and between network models; (g) executing computational algorithms for establishing the best fit of relationships and patterns for models of networks against some criteria; (h) providing feedback on the correctness or incorrectness of identified patterns and using learning algorithms reestablish the weights, relationships, and patterns of a model of networks; and (i) whereby extracted information based on patterns creates model of networks.

The second exemplary embodiment of the present invention, it will be appreciated, comprises a ‘network of networks’ comprising a set of networks containing resources, and the cross and between network interactions and systems of interactions between those networks. In this aspect, the present invention comprises models defining an ecosystem. An exemplary embodiment of the present invention comprises an ecosystem that operates as a common operating picture across a set of networks and their interactions. In the present invention an ecosystem may describe explicit and latent entities, sets of those entities, their relationships, rules, and information and operational flows regarding the entities and their relationships using description logic. In the present invention a network may consist of knowledge of resources and may be selected from a group comprising but not limited to people, policies, procedures, computer systems and information, and the interrelationships. In an exemplary embodiment of the present invention, descriptive information comprises digital information that is stored on a computer system. The processing of information comprises tokenizing information by parsing the information based on one or more algorithms. The algorithms define connections that establish proximity relationships between processed information and any other information in the system. In the present invention feedback comprises training and learning algorithms.

### Third Exemplary Embodiment

A third exemplary embodiment of the present invention comprises a method of computing to address a predetermined computing requirement involving the extraction, management, and merging of models of networks. This method comprises steps of (a) processing digital information; (b) establishing the connections between the processed information and any other information in the system datastore based on one or more algorithms; (c) describing those connections across n number of dimensions; (d) establishing the weights of the connections between processed information and any other information in the system datastore; (e) executing computational algorithms against the tokens and their connections for the purposes of identifying relationships and patterns; (f) executing computational algorithms for establishing the best fit of relationships and patterns against some criteria; (g) providing feedback on the correctness or incorrectness of identified patterns and using learning algorithms reestablish the weights, relationships, and patterns; and (h) whereby the resultant model defines interconnections between two or more networks.

The third exemplary embodiment of the present invention, it will be appreciated, comprises a ‘network of networks’ comprising a set of networks containing resources, and the cross and between network interactions and systems of interactions between those networks. In this aspect, the method comprises models defining an ecosystem. A exemplary embodiment of this method comprises an ecosystem that operates as a common operating picture across a set of networks and their interactions. In the disclosed method an ecosystem may describe explicit and latent entities, sets of those entities, their relationships, rules, and information and operational flows regarding the entities and their relationships using description logic. In the disclosed method, models comprise meta-data. In the disclosed method a network may consist of knowledge of resources and may be selected from a group comprising but not limited to people, policies, procedures, computer systems and information, and the interrelationships. In a further embodiment of the disclosed method, descriptive information comprises digital information that is stored on a computer system. The processing of information comprises tokenizing information by parsing the information based on one or more algorithms. The algorithms define connections that establish proximity relationships between processed information and any other information in the system. In the disclosed method feedback comprises training and learning algorithms. In the disclosed method connections are defined across n number of dimensions using mathematical equations for defining connections in terms of underlying fractal mathematical structure. The computational algorithm for establishing the best fit of relationships and patterns against some criteria including processing context descriptions. In the disclosed method, computational algorithms compute network attributes based on topological structures exhibited within and between information relationships and patterns. Further, in a exemplary embodiment of this method patterns implement neuro-cognitive models that simulate neurological, psychological and cognitive functions in computational algorithms. In an exemplary embodiment of the disclosed method models comprise representational logics and may be selected from a group that is not limited to: taxonomies, indices, ontologies, knowledge representations, semantic networks, and controlled vocabularies. In the exemplary embodiment of the disclosed method digital information may consist of system information. In the exemplary embodiment of the disclosed method network information comprises social network, computer network, network procedure or process information and other network knowledge. In the disclosed method, digital information may consist of information selected from a group comprising but not limited to: documents, spreadsheets, presentations, accounting reports, system descriptions, policy manuals, transactional data information that is stored on a computer system. System information may consist of computer system architectures, documentation, source code, and message logs. Transactional data comprises user computer behaviors.

In this method according to the third exemplary embodiment, processes of disambiguating information may consist of one or more processes for creating a common canonical format or root. File systems may comprise files organized based on fractal mathematic formula.

In the disclosed method according to the third exemplary embodiment, computation of topological features including number, type, strength, and weighting of connections between tokens. In the exemplary embodiment computational algorithms are selected from a group comprising but not limited to: classifiers, linear and non-linear statistical modeling techniques, latent semantic analytic techniques, genetic algorithms and evolutionary computation. Representational logics consist of languages and representational notation that describe the semantic definition of entities and their relationships. Representational logic is selected from the group comprising but not limited to: Extensible Markup Language (XML), DARPA Agent Markup Language (DAML), Web Ontology Language (OWL), Resource Description Framework (RDF), folksomony, collaborative tagging, social mark-up or other logical notation.

### Fourth Exemplary Embodiment

A fourth exemplary embodiment of the present invention comprises a method of computing a model of the relationships between two or more persons in one or more social networks. This disclosed method comprises the steps of: (a) processing digital information describing the persons and social networks; (b) establishing the connections between the processed information and any other information in the system datastore based on one or more algorithms; (c) describing those connections across n number of dimensions; (d) establishing the weights of the connections between processed information and any other information in the system datastore; (c) executing computational algorithms against the tokens and their connections for the purposes of identifying relationships and patterns; (f) executing computational algorithms for establishing the best fit of relationships and patterns against some criteria; (g) providing feedback on the correctness or incorrectness of identified patterns and using learning algorithms reestablish the weights, relationships, and patterns; and (h) whereby the resultant model defines the interactions between two or more persons in terms of shared content, process, and commerce. In this disclosed method relationship definitions may be selected from the group comprising: content produced by two or more persons, user profile data produced by two or more persons; user behavior produced by two or more persons. In the exemplary embodiment of this method, the relationship between two or more persons comprises a relationship weight. In a further exemplary embodiment the relationship between two or more persons across two or more social networks comprises a relationship weight. The weighting of the relationship may consist of an affinity measurement. In the exemplary embodiment of this method an affinity measurement comprises a statistical measure of the degree of similarity between two persons.

### Fifth Exemplary Embodiment

A fifth exemplary embodiment of the present invention comprises a method of computing a model of the relationship between one or more persons in one or more social networks and product offerings. The disclosed method comprises steps of: (a) processing digital information describing the persons, products and social networks; (b) establishing the connections between the processed information and any other information in the system datastore based on one or more algorithms; (c) describing those connections across n number of dimensions; (d) establishing the weights of the connections between processed information and any other information in the system datastore; (e) executing computational algorithms against the tokens and their connections for the purposes of identifying relationships and patterns; (f) executing computational algorithms for establishing the best fit of relationships and patterns against some criteria; (g) providing feedback on the correctness or incorrectness of identified patterns and using learning algorithms reestablish the weights, relationships, and patterns; and (h) whereby the resultant model defines the affinities between one or more persons in terms of product preferences, interests, and likelihood of purchase.

In the exemplary embodiment of this method processed information may be selected from the group comprising but not limited to: content produced by two or more persons, user profile data produced by two or more persons; user behavior produced by two or more persons and product descriptions. Relationships are identified through patterns organized as one or more neuron-cognitive models that describe the commerce process. A relationship between two or more persons may be defined through a relationship weight. A relationship between two or more persons and product interest comprises relationship weight. A relationship between two or more persons across two or more social networks and product interest comprises a relationship weight. In this disclosed method the weighting of the relationship may consist of an affinity measurement. An affinity measurement may be a statistical measure of the degree of similarity between a person and a product. In the disclosed method an affinity measurement comprises a statistical measure of the degree of similarity between two persons and a product.

### Sixth Exemplary Embodiment

A sixth exemplary embodiment of the present invention comprises a method of computing a model of the presentation of product information to a person based on a person's social relationships within a social network. The disclosed method comprises steps of: (a) processing digital information describing the persons, products and social networks; (b) establishing the connections between the processed information and any other information in the system datastore based on one or more algorithms; (c) describing those connections across n number of dimensions; (d) establishing the weights of the connections between processed information and any other information in the system datastore; (e) executing computational algorithms against the tokens and their connections for the purposes of identifying relationships and patterns; (f) executing computational algorithms for establishing the best fit of relationships and patterns against some criteria; (g) providing feedback on the correctness or incorrectness of identified patterns and using learning algorithms reestablish the weights, relationships, and patterns; and (h) whereby the resultant model defines the message content, offer, cost, promotion, schedule, and delivery mechanism between one or more persons and a product. In the disclosed method a personalized message based on social relationships may be selected from a group comprising but not limited to: content reflecting endorsement, interest, use, recommendation, and advice. In an exemplary embodiment of the method patterns may be selected from a group comprising but not limited to: neuro-cognitive models that define social influence, attitude change, social commerce, consumer decision-making, and social commerce patterns.

### Seventh Exemplary Embodiment

A seventh exemplary embodiment of the present invention comprises a method for creating an ontology of a network comprising steps of: (a) parsing digital information; (b) executing one or more computer processes that analyze the digital information for identifying various patterns; (c) executing one or more computer processes that analyze the patterns based on a specific context; (d) producing the output; (e) flagging the output as correct or incorrect, adjusting the weights of pattern relationships; (f) re-executing one or more computer processes that analyze patterns passed on specific context; (g) repeating the execution of processes, producing of output, and flagging the output until a correct model is produced; and (g) whereby the resultant model is transformed into an ontology. As will be appreciated an embodiment of the method ontologies may be of description logics including XML, OWL, and RDF.

### Eighth Exemplary Embodiment

An eighth exemplary embodiment of the present invention comprises a computer system operative to address a predetermined computing requirement involving the extraction, management, and merging of models of networks. The system comprises components including a digital information processing component, an affinity creation component, and an adaptation management component. The digital information processing component parses information, creates tokens of the parsed information and disambiguates the information. The affinity creation component discovers and executes one or more algorithms to establish connections between tokens and stores that information in the system datastore. The adaptation management component executes one or more algorithms within a specific context and establishes the patterns that best fit, and interprets correctness and incorrectness feedback and rewrites weights and relationships accordingly.

### Ninth Exemplary Embodiment

A ninth exemplary embodiment of the present invention comprises a computer system for creating ontologies comprising network modeling system and an ontology generation component. The component that processes information, defines entities and their relationships, and executes one or more algorithms based on specific patterns and exemplified in the present invention. The component that extracts the patterns and transforms the information into an ontology.

### Tenth Exemplary Embodiment

A tenth exemplary embodiment of the present invention comprises a method for creating a model of information within a network. This disclosed method comprises steps for (a) parsing digital information; (b) executing one or more computer processes that analyze the digital information for identifying various patterns; (c) executing one or more computer processes that analyze the patterns based on a specific context; (d) producing the output; (e) flagging the output as correct or incorrect, adjusting the weights of pattern relationships; (f) re-executing one or more computer processes that analyze patterns passed on specific context; (g) repeating the execution of processes, producing of output, and flagging the output until a correct ontology is produced; and (h) whereby the resultant model defines the information, the relationships between information, the relationship between information and persons, computer systems, processes, procedures, and policies. In the exemplary embodiment of the disclosed method information is selected from the group comprising: user profiles, lists of friends, user behavior, user preferences and other information that represents the user and the user's social relationships, computer system descriptions, computer system functional logs, computer system messages, process descriptions, procedures, financial data, folksomony, collaborative tagging, or social or individual markup, and other representations of knowledge.

### Eleventh Exemplary Embodiment

An eleventh exemplary embodiment of the present invention comprises a method for computing a predetermined computing requirement involving the optimization of outputs through the use of learning algorithms and feedback is also disclosed. The disclosed method comprises steps of: (a) producing information, its relationships, and weights within a specific context; (b) producing output; (c) providing feedback using one or more learning algorithms; (d) altering information, its relationships, and weights within a specific context based on feedback; and (e) whereby the resultant model is optimized based on user feedback within a specific context. In the disclosed method feedback comprises training of learning algorithms. Training of the computer system is provided by a user through a mark-up process. Training of the computer system may also be is provided by a computer system through a mark-up process. One aspect of the disclosed method is that training of the computer system is provided by a computer system through system operation.

### Twelfth Exemplary Embodiment

A twelfth exemplary embodiment of the present invention comprises a computer sub-system operative to address a predetermined computing requirement to optimize model outputs through the use of learning algorithms and feedback comprising: (a) learning algorithms; (b) algorithm manager: (c) datastore interface; and (d) user interface. In the disclosed method a learning algorithm comprises any functional process that alters processing, data model, or data attributes such as weights through feedback. An algorithm manager comprises a component that selects and invokes the specific learning algorithm in specific context. A datastore interface comprises a component that receives learning algorithm output and writes the necessary data regarding entities, relationships and their respective weights to the datastore. A user interface comprises a component that captures user feedback regarding algorithm output. In an embodiment of the method a learning algorithm may comprises a method that operates on an existing set of information and its relationships and performs one or more patterns analyses. Feedback comprises user or system responses to solution correctness or incorrectness delivered to the learning algorithm. In an embodiment of the method feedback comprises feedback defined within and for a specific context. Further, pattern analyses are neuro-cognitive models that mimic neurological, psychological or cognitive functioning.

### Thirteenth Exemplary Embodiment

A thirteenth exemplary embodiment of the present invention comprises a computer sub-system to address a predetermined computing requirement involving the store system data across in n dimensions within a specific context comprising a datastore, fractal mathematical algorithms, and n-dimensional algorithms. A datastore stores and retrieves data comprising information, relationships, patterns, context and data attributes such as weights. Fractal mathematical algorithms are based on fractal mathematical relationships or scale free network structures. N-dimensional algorithms comprises algorithms that define an object in relationship to other objects across n-dimensional mathematical dimensions using either n-dimensional calculus, graph theory, multi-dimensional geometry, vector decomposition, rasterizing or other graphical definitional algorithms.

### Fourteenth Exemplary Embodiment

A fourteenth exemplary embodiment of the present invention comprises a method of computing operative to address a predetermined computing requirement for the creation of entity and relationship weights based on frequency of use, traversal, access, and value within a specific context.

### Fifteenth Exemplary Embodiment

A fifteenth exemplary embodiment of the present invention comprises a method of computing to address a predetermined computing requirement for indexing a token using multiple indices and extracting the meaning of the token based on the establishment of vectors from one or more indices.

### Sixteenth Exemplary Embodiment

A sixteenth exemplary embodiment of the present invention comprises a method of computing to address a predetermined computing requirement for managing multiple index relationships.

### Seventeenth Exemplary Embodiment

A seventeenth exemplary embodiment of the present invention comprises a method of computing comprising algorithms that compete for best fit based on some predefined criteria and user feedback.

### Eighteenth Exemplary Embodiment

An eighteenth exemplary embodiment of the present invention comprises a method for extracting software programming logic from a network, such as a social network, comprising steps of: (a) parsing digital information from a network including social media; (b) executing one or more computer processes that analyze the digital information for identifying various patterns related to functional or process logic; (c) executing one or more computer processes that analyze the patterns based on a specific context; (d) producing the output; (e) flagging the output as correct or incorrect, adjusting the weights of pattern relationships; (f) re-executing one or more computer processes that analyze patterns passed on specific context; (g) repeating the execution of processes, producing of output, and flagging the output until a correct model is produced; and (g) whereby the resultant model is transformed into an process or functional logic which can used to define software functions.

Those of ordinary skill in the art will realize that any of the methods described above according to the first through eighteenth exemplary embodiments may be carried out by a machine, such a computer system executing program code for performing the specific steps.

### DETAILED DESCRIPTION

As will be explained hereinafter, the present invention comprises various systems and methods for modeling the form and function of networks comprising network resources such as human, information, computer, and process systems and, more particularly, to methods and systems for enabling the extraction, management and merging models of networks and creating models of networks of networks that can dynamically respond to changing context and computer requirements.

At its simplest, the term “network” is used to describe a set of entities that interact in some fashion. These interactions are defined by a set of connections. The connections have certain attributes that differ based on a specific context. Connection attributes include but are not limited to such things as to whether a connection is present or is not present in a specific context, the degree or extent of the connection, any conditional logic or rules that dictate the presence or weight of a connection. These connections are defined, within the context of the present invention, across n number of dimensions. These dimensions define sets of connection types for a specific entity. By way of example, an entity such as ‘car’ may connect to other entities such as date/time entities across one set of dimensions, may connect to entities describing uses across another set of dimensions, may connect to entities describing users across another set of dimensions, and so forth.

Network entities can consist of, but are not limited to, such entity types as computer systems including hardware and software, persons or groups of persons, information or groups of information, policies, procedures, products and processes. Within a specific network, all entities may be the same, or there may be a mixture of entity types dependent on context. In the typical implementation described herein, a network consists of computer resources such as services, persons, computer systems, software, explicit and implicit policies, procedures, and processes that interact within a specific context and define interactions and information flows.

An additional term is ‘network of networks’. Networks of networks imply that networks can interact with other networks, be nested or subsume or be subsumed by other networks. Networks can be composed dynamically based on a specific context. An example is that based on a specific context a network of computer systems interacts with a network of users. The resultant interaction creates a new multi-dimensional set of relationships between the two primary networks. The above-referenced term may be better understood with reference to a specific example. A marketing ecosystem, or ‘network of networks’ consists of Retailer (“Franks Grocery Stores”), a number of manufacturers (“Tim's Crackers”, “Paul's Soup”), a set of marketing communications offers (“A sweepstakes”, “A video”), an online coupon publisher (www.downloadcoupons.com), a social network (“Shoppers Network”), a set of consumers “Bill”, “Tom” and “Sally”), and an automated video rental kiosk (“We-Rent-Videos”). Each of these entities has a network of people and content associated with them. So, Paul's Soup has a set of known customers who have either purchased the soup or who have responded to marketing programs associated with Paul's Soup. A consumer like Bill has a set of purchase patterns that includes Tim's Crackers. Bill also has a set of online relationship in the Shopper's Network as well as a set of friends. A ‘network of networks’ constitutes the interconnections between all of these listed networks in terms of people, content and function.

An additional term is ‘context’. Context describes the circumstances and conditions which a specific network that defines the entities, the entity types, the entity attributes, and the connections and the connection attributes. Examples of context include date, time, creator, view, uses, and network state.

An additional term is ‘fractal’. Fractal relationships describes mathematical characteristics of networks in which network patterns have statistical self-similarity at all resolutions and the underlying generated by an infinitely recursive process. Fractal attributes of networks consist of geometrical and topographical features are recapitulated in miniature on finer and finer scales. Fractal relationships are reflective of broader structures found within networks. These structures have been described as the Power Law or Scale free characteristics of networks. The present system operates utilizing fractal and therefore topological structures defined within the data to optimize storing, processing, and discovery of associations. Topographical or topological features consist of network structures that define entity cluster across and within dimensions. Topological features include but are not limited to small world clustering, shortest path, numbers of connections, etc.

An additional term is ‘adaptation and learning’. Adaptation and learning is used to describe specific algorithms that are adopted in the present invention. Adaptation and learning describes an architectural attribute of the present invention. Adaptation and learning describes an architectural structure, process or functional property of the algorithms in which the algorithm evolves over a period of time by the process of natural selection such that it increases the expected long-term reproductive success of the algorithm. Operating in the present invention, the actual computer system operates as a complex, self-similar collection of interacting adaptive algorithms. The present system behaves/evolves according to three key principles: order is emergent as opposed to predetermined, the system's history is irreversible, and the system's future is often unpredictable. The basic algorithmic building blocks scan their environment and develop models representing interpretive and action rules. These models are subject to change and evolution. The exemplary embodiments of the present invention described herein operate using algorithms built on adaptational and learning models. Examples of these algorithms include evolutionary computation algorithms, biological and genetic based algorithms and chaos based algorithms.

An additional term is ‘neuro-cognitive’. Neuro-cognitive defines the type of models in the present invention that is represented and enacted using algorithms and subject to adaptation and learning. Neuro-cognitive models are functional models. These models simulate neurological, psychological or cognitive functions. These models are unique in implementation because they presume connectionism, parallelism, and multiple solutions or outcomes.

Finally, an additional term is ‘ecosystem’. An ecosystem is a term coined for the present invention and is an ex emplary embodiment. It is meant to convey an ontological representation. An ontology is an explicit, formal specification of how to represent objects, concepts, and other entities and the relationships that hold among them. These specifications may or may not be hierarchically structured. As used herein, “ontology” or “ontological model” is used to describe conceptual models that describe concepts and their relationships. These models rely upon a logical framework (i.e., “formalism” or “description logic”) that describes how these concepts and their relationships can be represented. As described herein, an ecosystem is an ontological model that is defined across multiple contexts and represents concepts and their relationships in terms of adaptational algorithms based on neuro-cognitive models. An eco-system differs from a traditional ontology in the following ways: (1) it is multi-dimensional and reflective of multiple contexts, (2) it is adaptive in that entities and their relationships are evolving through the use of weightings of those entities and relationships that alter through use, and (3) the entities and their relationships are emergent and are derived from algorithms rather than explicitly defined. The entities and relationships exist latently and are not explicitly defined.

Rather than explicitly defined, an ecosystem contains information about entities and their relationships that have been extracted from latently defined framework which consists of concepts (e.g. “Today is Monday”), properties to be associated with concepts (e.g., “Date has month/day year”), rules to applies to concepts (e.g., “Departure Date must be before Return Date”), and queries to be run (e.g., “Provide Travel Itinerary”). The logical framework also enables relationships to be defined among concepts, for example by using constructors for concept expressions such as “unions,” “negations,” number restrictions,” or “inverses.” “Semantics” is a word that merely means “of or relating to the meaning of language.” While the term ontologies is used in the exemplary embodiments of the present invention, it is used merely for illustrative purposes and should not be seen as solely as a method of ontological generation.

The above-referenced terms may be better understood with reference to a specific example. Franks Grocery Stores, a retailer decides that they wish to improve the sale of their cracker category and approaches a manufacturer, Tim's Crackers. Franks Grocery Stores have over 100 locations and Tim's Crackers are not sold in every store because Tim's Crackers is a high-end gourmet cracker. Tim's Crackers are sold in a large number stores besides Franks Grocery Stores. The result is a complex network of consumer and retailer relationships that precede the discuss of improving sales. Both companies decide that they wish to market and position crackers as less gourmet and a more natural, organic food product. This decision sets the context. Market research is conducted and determines that highlighting the fat content in the crackers is the key factor in repositioning the category as organic. This market research represents a corresponding neuro-cognitive model. The model contains key psychographic, behavioral, demographic and associated insights involving the relationship between crackers, fat content and organic in the mind of the consumer. Franks Grocery and Tim's Crackers decide to create two video promotions available for download from a popular video site.

Thus far, we have a complicated ecosystem of retailer, manufacturer, and consumer networks. Within these networks is considerable insight and behavior regarding crackers, grocery, and repositioning of the cracker category as an organic food. This is the complex marketing ecosystem. The complex interrelationships between the entities in this marketing ecosystem can be represented as a set of nested relationships that conform to conform with fractal mathematical representations. Consumers are presented the two versions of the video and the adoption rate is tracked. With each download the gains feedback and the underlying weights of relationships within the system changes creating a micro-targeted understanding of consumers and their future behavior.

System Overview

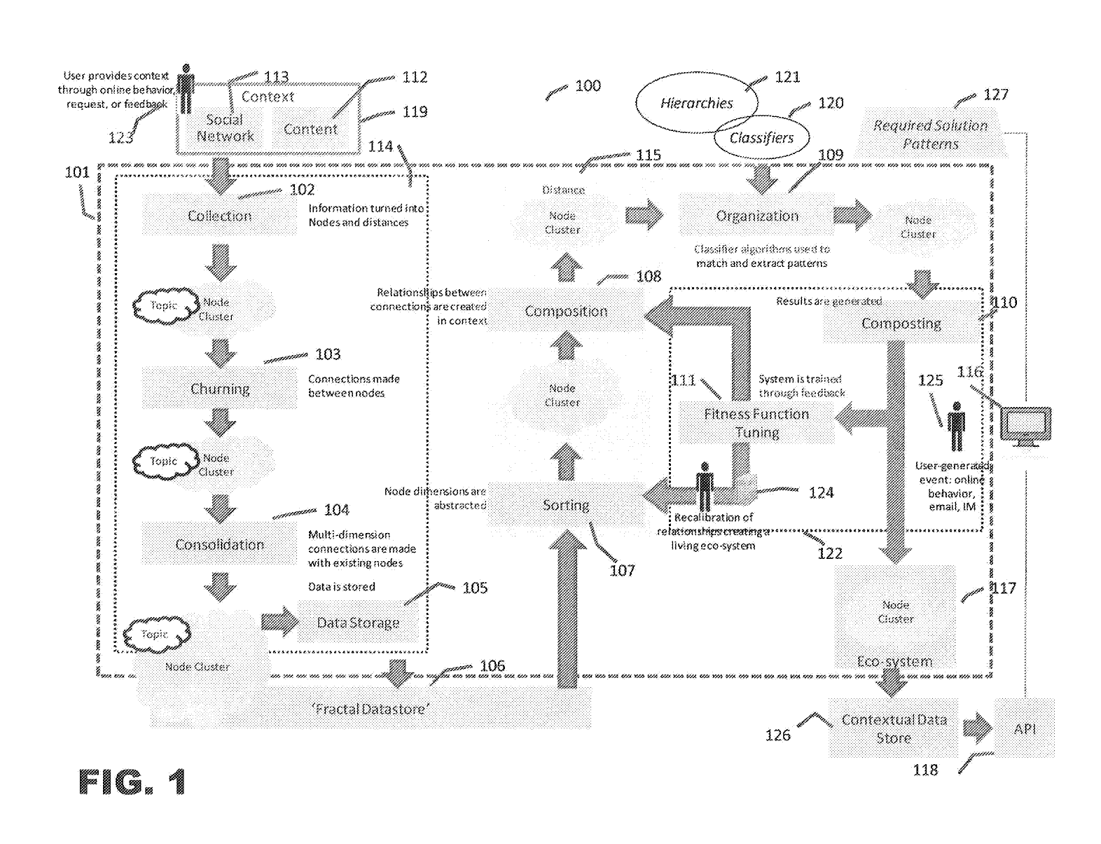

Turning first to FIG. 1, a schematic diagram of a computer system 100 according to an exemplary embodiment of the present invention is illustrated. A primary element of the computer system 100 is a system for the auto-generation of network models 101, which includes a number of components (102, 103, 104, 105, 106, 107, 108, 109, 110, and 111) and carries out a number of steps, as will be described in detail hereinafter. Specifically, the computer system for the auto-generation of network models 101, includes an information processing component 114, an affinity generation component 115, an adaptation manager 122, and a fractal datastore 106.

The information processing component 114 processes existing network models 113 and digital information 112. These are termed ‘artifacts’. Network models consist of information that describes the entities and their relationships for one or more networks. Network entities consist of computer systems, information, persons, procedures, processes, and any other entity or object that is related to any other object. Relationships consist of explicitly define connections or interactions between entities, and latent relationships which may be established through various statistical and analytic techniques that are capable of deriving relationships between entities. Network models include output from the present invention or, for example, ontologics, taxonomies, relational data models, file structures, XML schemas, controlled vocabularies, the Unified Modeling Language (UML), and other graphical or narrative descriptions of entities and their relationships. Digital information 112 includes, for example, network models, documents, spreadsheets, software code, computer transaction logs, message logs, emails, instant messages, web pages, databases, directory services for users and groups of users, file systems, digital media, digital media and content repositories, enterprise resource repositories, enterprise metadata repositories, web services, web service directories, application programming interfaces, message specifications, network and system management systems, and knowledge management systems.

Broadly described, digital information 112 is processed and associations are created within the specific artifact 103 and further associations are created with data already in the datastore 106. The result is an n-dimensional graph in which every token (or node) is connected with every other node. A user 123 creates contextual information 119 and events 125 that results in extraction of sub-graphs from the datastore and stimulation of algorithms that identify relevant dimensions and then the relative distance of dimensions and nodes across dimensions. Algorithm composites 121 are then executed against the resultant data. Another user 124 examines the result set and using feedback and adaptational or evolutionary algorithms optimizes the algorithm compositions for best tit. The result is an optimized algorithm and result set for the specific context 126. This result set can be transformed into a format that is processable by a third party computer system.

It should be understood that the independently-operating or pre-programmed third party computer systems 116 may also be operative to access, invoke and execute eco-systems automatically such as at pre-programmed times, or in response to particular input stimuli that causes such independently-operating computer systems to run a program to access the computer system 100. Thus, although the discussion in the examples which follows exists primarily in the context of the formation and output of a network model, it should be understood that the examples apply equally regardless of whether the models are accessed through a user interface on the initiation of an end-user's computer system 116, or an automated third party computer system 118.

By way of an illustrative example, a program for a mobile device may be written that allows a consumer to provide access to multiple personal profiles contained in online applications. The consumer chooses to integrate those profiles for the purposes of more effectively managing personal profile information, and using that information to communicate with manufacturers about product preferences. The user provides the profile user ID and password. The system retrieves available information about the user. This is information is an artifact and represents a discrete network. The computer system 100 processes each set of profile information in the manner described herein. As each artifact containing a user's profile for a specific application is processed, the computer system is creating associations between the profiles. As an example, a user has a profile in a shopping network that indicates the user prefers ‘gourmet crackers’. In another profile, the user's profile indicates ‘an interest in gourmet cooking’. The system would create an association between these two profile elements because they share the string ‘gourmet’. This association would be made to other associations already contained within the system that indicates a relationship between ‘gourmet’ and ‘cooking’, and with ‘food’. Associations are also created that creates and associations ‘crackers’ and ‘cooking’ because of the associations between the two phrases. The result is an n-dimensional graph in which every string has been represented as a token in the graph and an association is created between every node and every other node. The mobile application solicits from the user a context such as ‘gourmet cooking’ or ‘shopping’. The user selects the ‘shopping’ context. The system then selects the graphs that are related to the ‘shopping’ dimension. Marketers have created a number of models for understanding gourmet food models based on marketing theory and research. The marketers have translated this into algorithms. When the user selects the ‘shopping’ context the algorithms associated with ‘shopping’ are activated. As the user views results and interacts with the system the user's behavior acts as feedback. Each result that is select provides positive feedback to the system and each result that is not selected provides negative feedback. With feedback the adaptational or evolutionary algorithms optimizes the algorithm compositions for best fit.

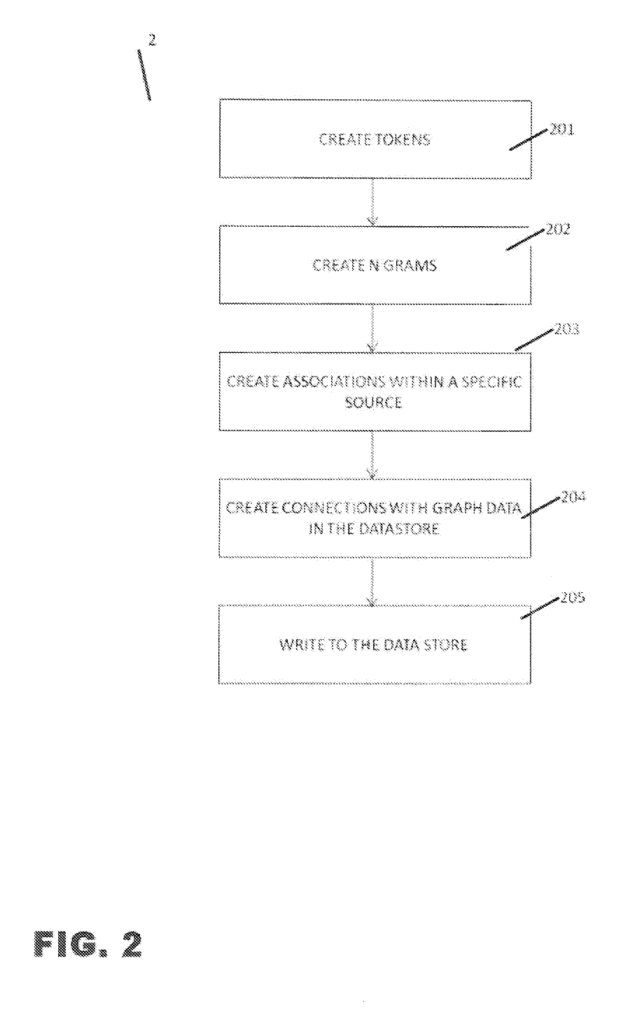

The processing of digital information 112, by the information processing component (termed “garbage eater”) 114, occurs through series of steps described in detail hereafter (FIG. 2). The term ‘garbage’ is used herein to described the characteristics of the unstructured data process in the computer system described herein. Unstructured data is inherently inconsistent, gap filled, contradictory and absent a prevailing overall structure. As a result there is considerable extraneous information which is not relevant and information that is error filled. These characteristics constitute the ‘garbage’ of Internet content. In Step 1 (201) the garbage collection operation 102 is executed. Digital information is processed with specific context 119 information. Context consists of any or all meta-data defined at the time of the processing of the digital information. Context can be defined by a user or by the networking modeling system 100. The garbage collection operation parses and tokenizes digital information and disambiguates the information tokens. Hereinafter, the term ‘token’ will be used to represent the individual datum that results from the parsing and disambiguation process. It should be further understood that since these tokens are represented in the form of a token and its relationships, a graph, that a token and a node are synonymous and are used interchangeably but are assumed to have equivalent meaning.

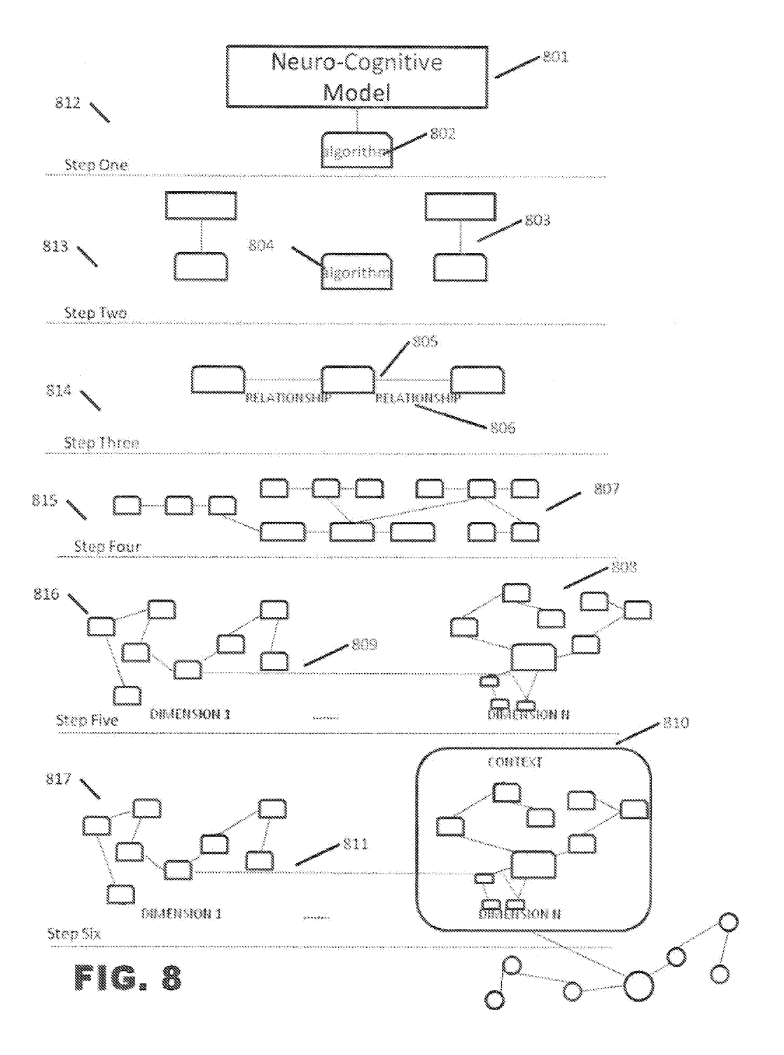

For those familiar with the state of the art, disambiguation is the process of determining in which sense a word having a number of distinct senses is used in a given sentence. In Step 2 (201) n-grams are created for each token. An n-gram is a sub-sequence of n tokens from a given sequence. Each n-gram may be associated with the specific context. Following garbage collection 102, Step 3 (202) a garbage churning process 103 is executed. Each token is associated with every other token using n-gram as the association mechanism for the specific digital information set. Distances, computed as the number of tokens separating a pair of tokens are computed. Additional associations are also computed as a result of explicit and latent hierarchical structural relationships and other association patterns (FIG. 8). Following generation of associations, in Step 4 (203) the garbage consolidation process 104 is executed. This process creates associations between tokens from the processed information with tokens and associations already stored in the fractal datastore 106. As a final step, Step 5 (205) in the flow, the garbage is written 105 to the datastore 106.

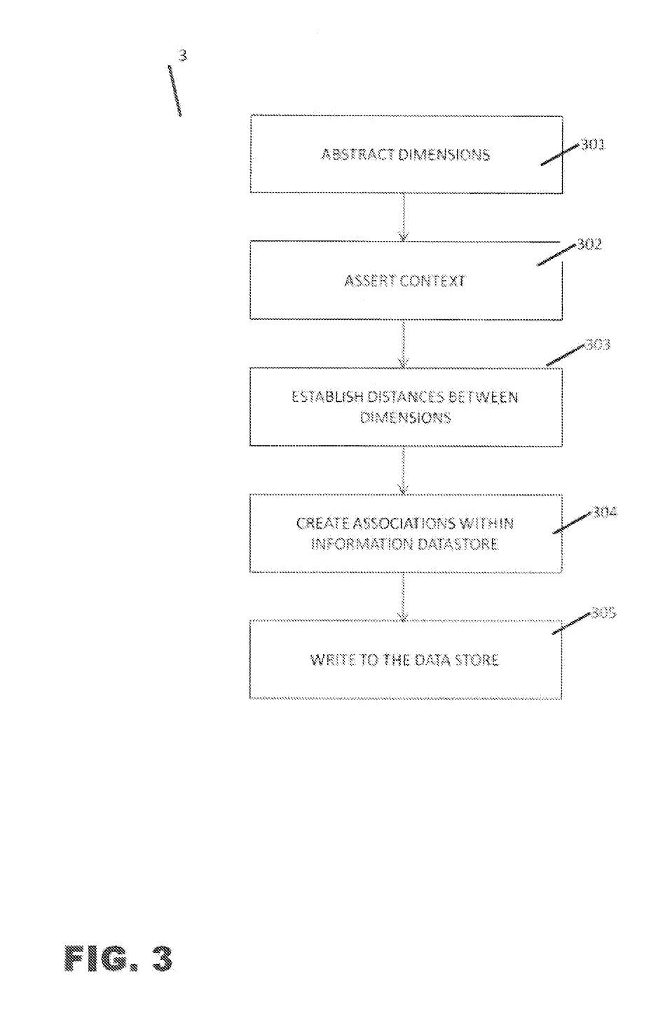

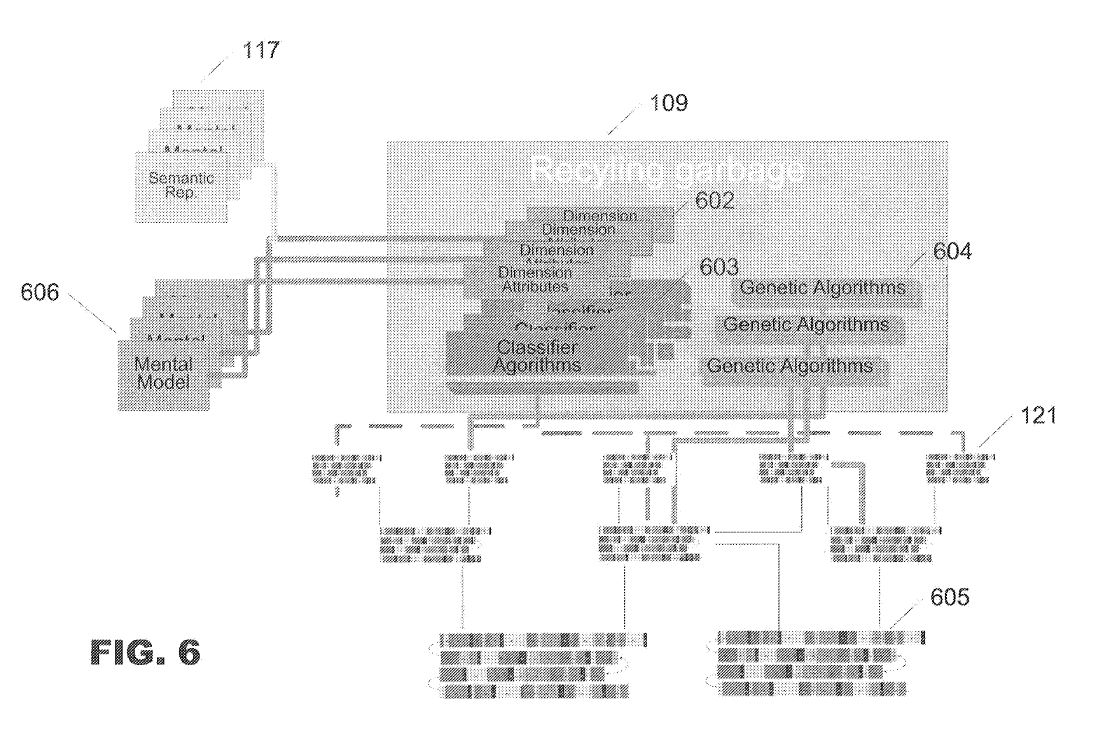

In FIG. 3, affinities or associations are generated. In Step One (301) algorithms are used to extract the underlying dimensions of the graphs created during the processing of digital information in the garbage eating process. Algorithms identify explicit and latent dimensions identifiable with the topological structures of the n-dimensional graph. In Step Two (302) a user 123 will assert a context 119. A context determines which sub-graphs and corresponding dimensions within sub-graphs are processed using one or more algorithms. In addition, events are captured (e.g., user action, emails, Instant Messages (IMs), mashups, content syndications, social networking). The context and events are used to isolate dimensions within the n-dimensional graph. The distance between dimensions and nodes within each dimension is established during Step Three (303). In Step Four (304) further associations are made through the use of algorithms that are implementations of neuro-cognitive models (see FIG. 6) The use of these algorithms allows eco-systems to emerge by stimulating algorithms to discover recommendation pattern. In Step Five (305) the resultant data may be written back to the datastore 116.

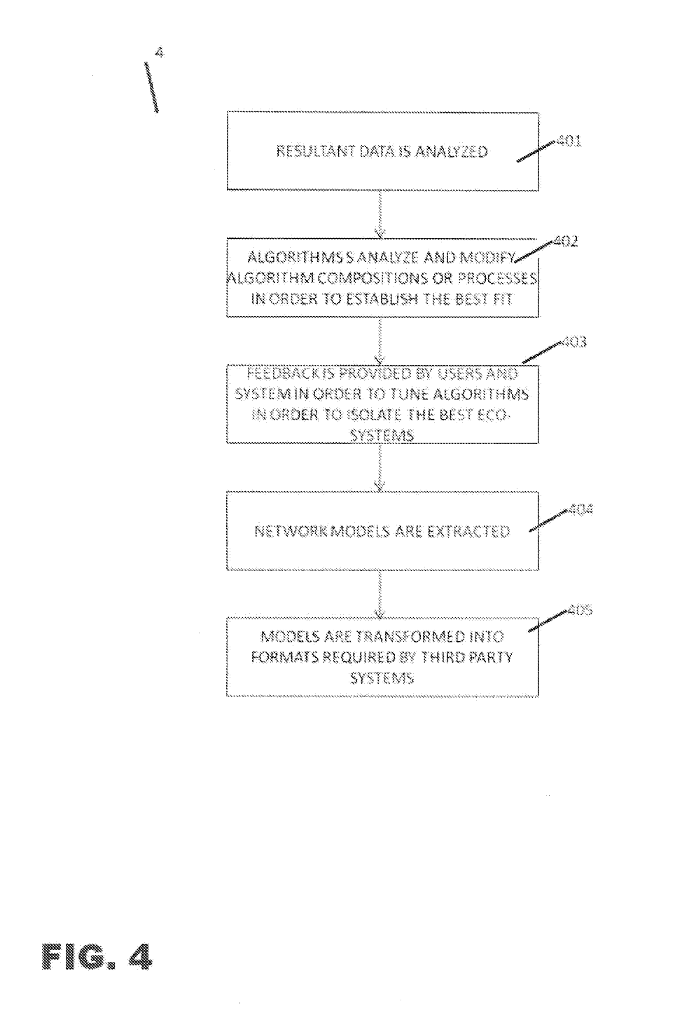

In FIG. 4, resultant data is analyzed Step One (401). Algorithms such as genetic algorithms analyzing and modify algorithm compositions or processes in order to establish the best fit Step Two (402). Feedback is provided by users and system in order to tune algorithms in order to isolate the best eco-systems Step Three (403). Network models are extracted Step Four (404). Models are transformed into formats required by third party systems Step Five (405).

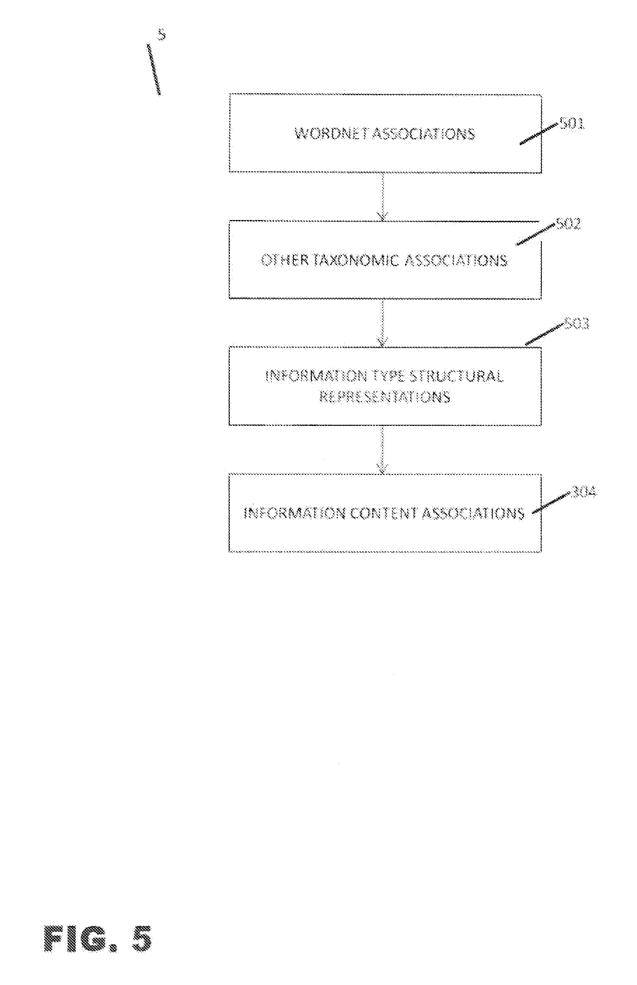

FIG. 5 shows an exemplary method for creating associations between tokens using explicit and latent structural relationships as well as other association patterns. Associations can be extracted by using structural hierarchical relationships using Wordnet or other semantic and ontological models at Step One (501). Wordnet is a dictionary that also asserts synonyms, and more general and specific meanings of terms. By using these semantic hierarchies new associations can be created as the new tokens are processed. Associations can also be extracted from other semantic structures such as thesauri and taxonomies at Step Two (502). Associations are also created using various structural properties of various information types at Step Three (503). By way of example, XML schemas have a specific hierarchical structure which can be extracted and that hierarchy can be used to create additional associations. Associations can also be created by using domain knowledge to define structural relationships within specific content at Step Four (504). By way of example, a political blog may have certain structural relationships that can be extracted such that minor terms can be separated from more significant terms. They can be domain specific or document-type specific. For example, a generic text or xml or http parser that understood more of the structure could be used to create hierarchical relationships of words to tags (xml) or words to sentences to paragraphs (text). Another example is an e-commerce product load database, which has to be in a particular format or specialized parser in order to set the right groupings of data.

FIG. 6 provides further detail of the adaptation management 115 and specifically the garbage recycling operation 109 shown in FIG. 1. A neuro-cognitive model 606 and specific ecosystems 117, which serve as a context, defines specific dimensions 602. These dimensions are expressed in the form of algorithms 603 which compete for the best fit using various genetic-type algorithms 604. Those familiar with the state of the art will know that genetic algorithms represent a family of evolutionary algorithms (also known as evolutionary computation) that use techniques inspired by evolutionary biology such as inheritance, mutation, selection, and crossover (also called recombination). An evolutionary algorithm is a generic population-based metaheuristic optimization algorithm. Candidate solutions to the optimization problem play the role of individuals in a population, and the cost function determines the environment within which the solutions “live.” Evolution of the population then takes place after the repeated application of the above operators. These competing algorithms create larger algorithm compositions which are described in detail hereinafter (See FIG. 8). As will be further understood by those familiar with the state of the art, genetic-type algorithms are one of a many different types of algorithms that can be used for creating optimized solutions. The use of genetic-type algorithms is presented as an example and it should be understood that the systems and methodologies of the present inventions are applicable within the context of any algorithm that operates to create optimized solution sets using criteria of adaptation, emergence, and latent analysis. Another example of an algorithm that might be used is algorithms from chaos and complex systems. Thus, the present invention should not be limited to or construed to be limited merely to the genetic algorithm applications. The result is algorithm hierarchy 605 operable within a specific context as defined by the specific ecosystems 117.

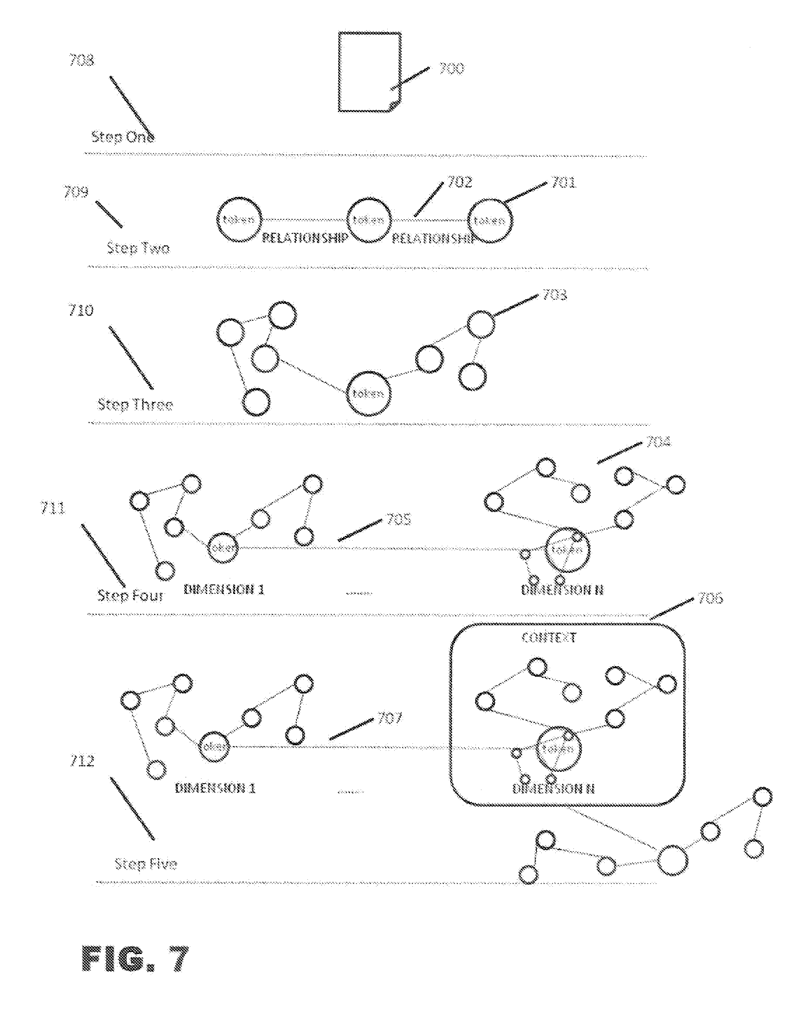

FIGS. 7-14 are presented for illustrative purposes to describe the underlying structure of the data and its existence as an n-dimensional graph of associations. An n-dimensional graph is a complex graph that can be mapped mathematically to n-dimensions in some topological space whose dimension are n. The archetypical example is a n-dimensional Euclidean space, which describes Euclidean geometry in n dimensions. An n-dimensional space can typically be defined using a vector calculus (also called vector analysis) which is a field of mathematics concerned with multivariate real analysis of vectors in a metric space with two or more dimensions. Vector calculus is concerned with scalar fields, which associate a scalar to every point in space, and vector fields, which associate a vector to every point in space. For example, the temperature of a swimming pool is a scalar field: to each point we associate a scalar value of temperature. The water flow in the same pool is a vector field: to each point we associate a velocity vector. Vector calculus operations are functions between scalar and vector fields.

While the use of vector calculus is described in connection with the exemplary embodiments of the present invention, such is used for illustrative purposes only, and those of ordinary skill in the art that various other means and methods may be used. The use of dynamic system models, commonly called ‘chaotic’ models, may also be used to define the underlying network models described herein. Chaos-based systems are commonly found to have the following properties evident in these network models: (1) they are sensitive to initial conditions, (2) they evolve over time so that any given region or open set of phase space will eventually overlap wth any other given region (commonly referred to as “topologically mixing”), and (3) their periodic orbits must be dense.

FIG. 7 is a flow diagram illustrating in greater detail the steps that occur with association creation. In Step One (708), digital information 112 is processed. In Step Two (709), the information is tokenized 701 and disambiguated and relationships 702 are created in the form of n-grams creating a graph. In Step Three (710), associations are made in the form of asserted relationships 702 with other n-grams that share the same token value 701. In Step Four (711) the resultant graph 704 can be decomposed through one or more functions as have one or more structural dimensions across all ecosystems 117. A specific token can exist across multiple dimensions 705 across all ecosystems 117. In Step Six (712), for a specific context 119 one or more dimensions 710 are identified comprising n number of tokens and corresponding associations in the form of a graph for an identified set of one or more ecosystems 117.

FIG. 8 is a flow diagram illustrating in greater detail the steps for algorithm composition, dimension extraction and hierarchy creation. It should be understood that the created hierarchies are represented as a set of n-dimensional nested relationships. In Step One (812), a neuro-cognitive model 606 is implemented as one or more algorithms 802. In Step Two (813), One or more algorithms as expressions of one or more neuro-cognitive models 503 are identified for one or more specific ecosystems 117. Step Three (814) can be implemented using evolutionary computation algorithms which use machine learning to optimize the combination and weighting of algorithms to form asserted relationships 806 resulting in a composite algorithm 505. When viewed across multiple ecosystems the single composite algorithm would have through identified compositions reflective of a complex graph of associations as illustrated in Step Four (815). Thus the optimized algorithm represents the optimized n-dimensional graph. Using an additional set of functions this graph can be decomposed into and represented as a set of values contained within multiple structural dimensions 509 as illustrated in Step Five (816). In Step Six (817), a graph 810 including one or more dimensions for a specific context 119 is identified comprising n number of algorithms and corresponding composite algorithms. These algorithms can be represented in the form of a graph 810 for an identified set of one or more ecosystems 117. It should be evident to those familiar with the state of the art that these composite algorithms represent a sequential execution of algorithms that describe a process or function flow. It should also be evident that the output of the composite algorithms results in a set of nested data relationships which could be further defined in a set of fractal mathematic relationships.

As discussed above with regard to FIGS. 7 and 8, the ability to run certain algorithms against one or more networks results in a dimension. Multiple dimensions allow for the identification and/or vectoring of the nodes in the original artifact. These dimensions as abstractions of the original nodes can themselves be used in a nested fashion. For example, consider an artifact which is ‘March Madness’ college basketball bracket. The dimensions that may be extracted could include “gambling,” “sports,” “basketball” and “championship.” These dimensions can in themselves be abstracted and used as search parameters. For instance, a Google search of these four terms suggests that there are 6,940,000 webpages that contain these terms. So these four dimensions map to 6,940,000 webpages. By using these four dimensions we have matched an artifact to 6,940,000 nodes in a Google network. This example represents the fractal (nested) nature of a data structure, and the ability of a computer system to manage the same to generate a network model.

A neuro-cognitive model is an a priori theory or postulate about a phenomenon. For example, a neuro-cognitive model might explain a ‘happy marriage.’ A specific neuro-cognitive model might define a ‘happy marriage’ as a combination of ‘good communication’ and ‘parent date nights.’ A human might further translate ‘good communication’ into a specific number of statements like “good talk,” “nice talk” or “thanks for sharing.” A method such as described above with reference to FIG. 8 would utilize algorithms to measure the appearance and number of statements like “good talk,” “nice talk” or “thanks for sharing.” As discussed above, these algorithms may evolve through computer learning so that certain terms are weighted more heavily than others, resulting in a composite algorithm. The algorithms may also be optimized through feedback from users, so that statements like “good talk,” “nice talk” or “thanks for sharing” can be more easily identified.

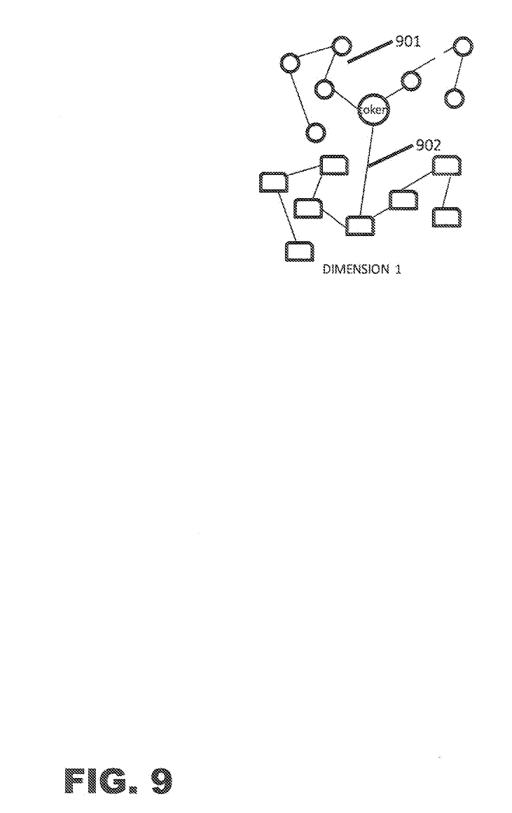

FIG. 9, extends FIG. 8 by providing additional detail regarding Step Six (817). FIG. 9 illustrates exemplary dimensional associations for the graph 810. FIG. 9 illustrates in greater detail that further associations can be defined between graphs of algorithms (e.g., graph 810) and graphs of tokens 901 whereby a specific token may have associations with one or more algorithms within a specific dimension 902. FIG. 9 illustrates a multi-dimensional space that incorporates a token, and its associated to tokens, represented in the form of a graph 901, and then a set of dimensions determined through the use of algorithms in creating relationships' between tokens and the graph 810.

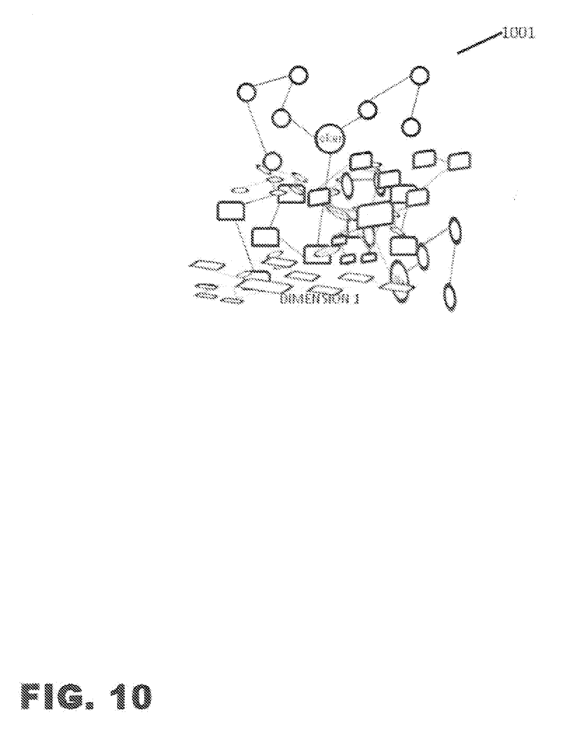

FIG. 10, extends FIG. 9, by illustrating an additional dimension in which the dimension 902 associated with graph 810 in itself has a related dimensions 1001 resulting in a set of infinitely nested relationships as established through algorithms.

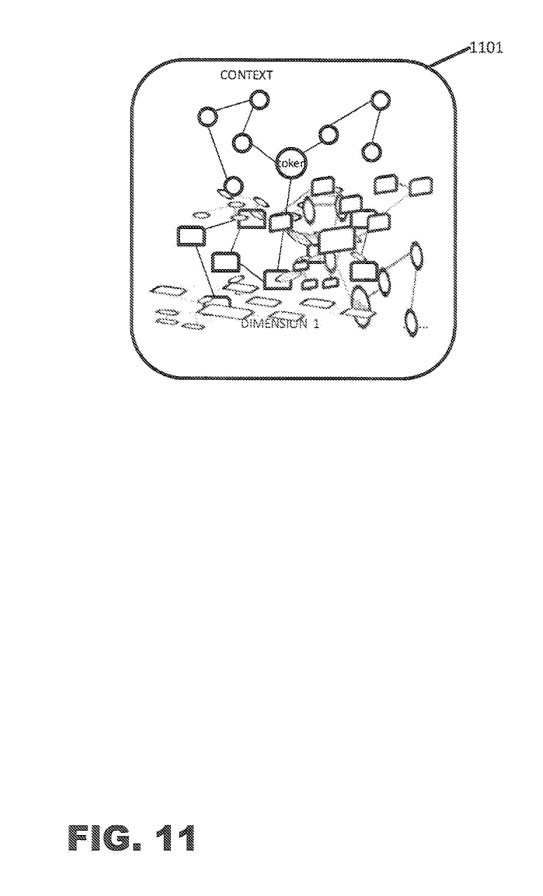

Further illustrating the infinite nesting of algorithmically determined dimensions 902, 1001, FIG. 11 extends FIG. 10 and illustrates in greater detail the associations of graphs of algorithms and graphs of tokens across multiple dimensions 1101 for a given context 119 to specific graph 810. In this example the set of dimensions in relationship to the original graph node 810 is defined in a multi-dimensional space and as determined by a specific context. By adding context, FIG. 11 implies that a different context would create a different set of relationships between various nested dimensions 902, 1001 and the original graph 810 including the creation of new dimensions or relationship strengths.

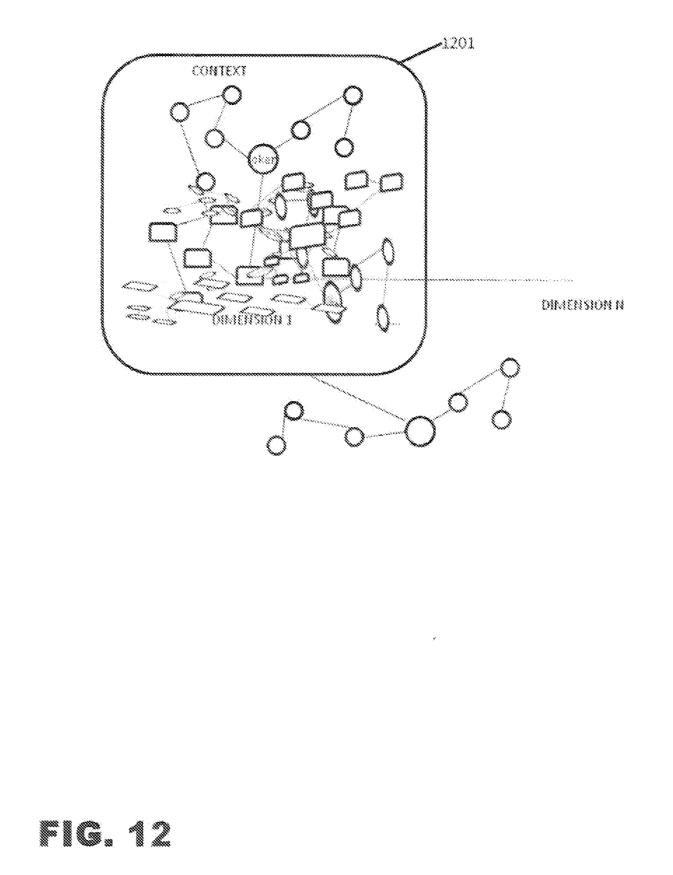

As described above, different contexts create and define different relationships between the core graph (e.g., graph 810) and the definitional dimensions (e.g., dimensions 902, 1001, etc.). A different context would create a different set of relationships between various nested dimensions 902, 1001 and the original graph 810 including the creation of new dimensions or relationship strengths. FIG. 12 extends FIG. 11 and illustrates the resulting the effect of the altered context. FIG. 12 illustrates the resultant graph of associations of algorithms and tokens across multiple dimensions within a context which in itself can act as a dimension. Algorithms utilizing fractal mathematics can be used to define these n-dimensional, nested relationships between dimensions.

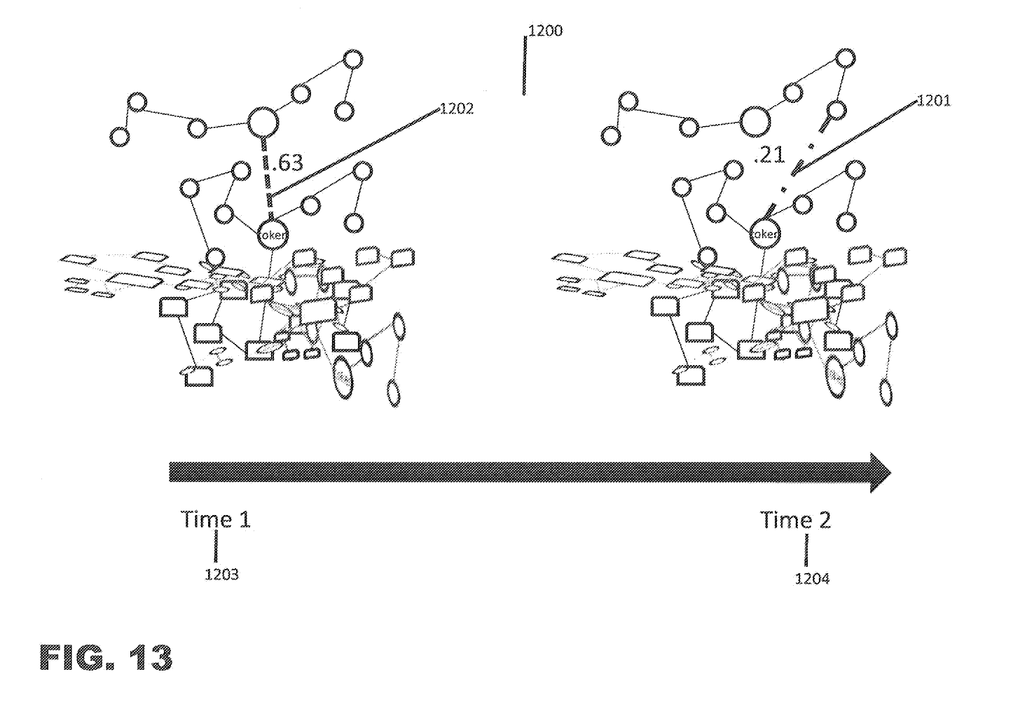

In addition to changes in context, time acts as context and does affect the relationships between the core graph and the dimensions. Therefore, as time changes, the relationships in the graph also change. FIG. 13 extends FIG. 12 and illustrates the effect of the altered context of time on the organization of the graph and the dimensional weights. FIG. 12 illustrates the resultant graph of associations of algorithms and tokens across multiple dimensions within a context that evolves and adapts over time. At Time 1 (1203) an association 1202 exists. This association 1202 may be between tokens, between algorithms or between tokens and algorithms. At Time 2 (1204) the association has evolved and comprises a different association 1201. This evolution occurs as a result of several factors including changes in context, alteration in association weights through computer system functioning or through training and optimization functions as illustrations.

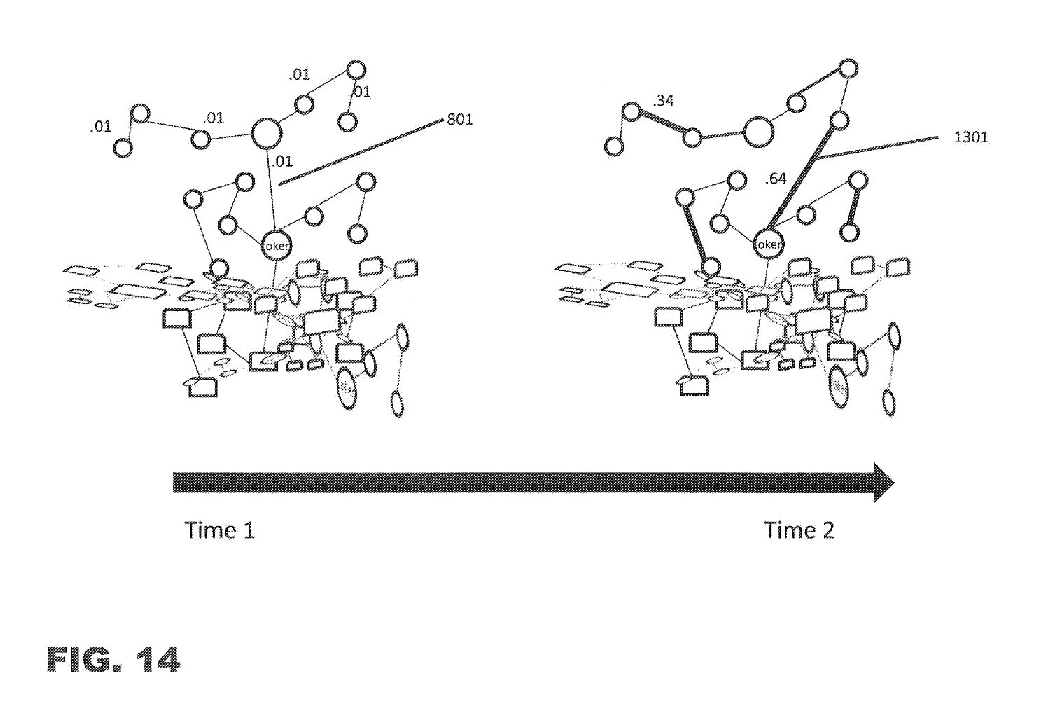

FIG. 14 extends FIG. 13 and illustrates the changes in association strength and weights that occurs in resultant graph of associations of algorithms and tokens across multiple dimensions within a context. At Time 1 (1303) an association 1302 has an association weight of 0.01. An association may be between tokens, between algorithms or between tokens and algorithms. At Time 2 (1204) the association 1301 has weight that has been strengthened, and is now 0.64. In the graph at Time 2 (1204) other associations have changed as well. In the present illustration a single weight has been presented. However, in the exemplary embodiment of the invention multiple weightings exist across multiple varying contexts. In the present illustration a single value is presented as a weight. However, in the exemplary embodiment of the invention weightings may consist of one or more association attributes that can themselves be represented in a multi-dimensional graph. Association weights represent the strength of an association within a given context and are generated using one or more algorithm outputs. Strength of associations, presented in the form of weights, occur through computer system functioning, feedback, training and as outputs of optimization functions as illustrations.

FIG. 7-14 describes the logical graph model in the present computer system. Specifically, these figures illustrate that nodal relationships within the graph, and the relationships between nodes and topical dimensions are highly dynamic and fluid. For example, an understanding of specific consumer (“Bob”) at Franks Grocery alters significantly based on context. Franks Grocery's understanding of Bob can be based on a number of artifacts. Bob may have a shopping history, a set of responses to survey questions, and a history of responding to various promotions in the past. Bob's shopping intent is different when shopping during regular shopping trips on Mondays compared with a shopping trip the day prior to his wife's birthday. The extent that Bob's affinity with Organic Foods or Natural Foods (a dimension that can be used to characterize Bob) shifts depending on what and where he is shopping. Bob is more likely to be highly related to Organic Food when he is on his regular shopping trips as compared to a special occasion. In this example, the impact of intent, time and context have been described and suggest that the relationships and weights within an explanatory graph are different. Discovery of associations using the underlying explanatory dimensions will be vastly different if the context is the regular Monday shopping trip in which Organic Food is weighted particularly strong. Therefore, other Organic Food relationships would be particularly relevant to Bob. However, Organic Food may be a less relevant explanatory dimension compared with Chocolates. Romantic Vacations, and Wine when the context is the day before Bob's wife's birthday.

System Architectural Detail

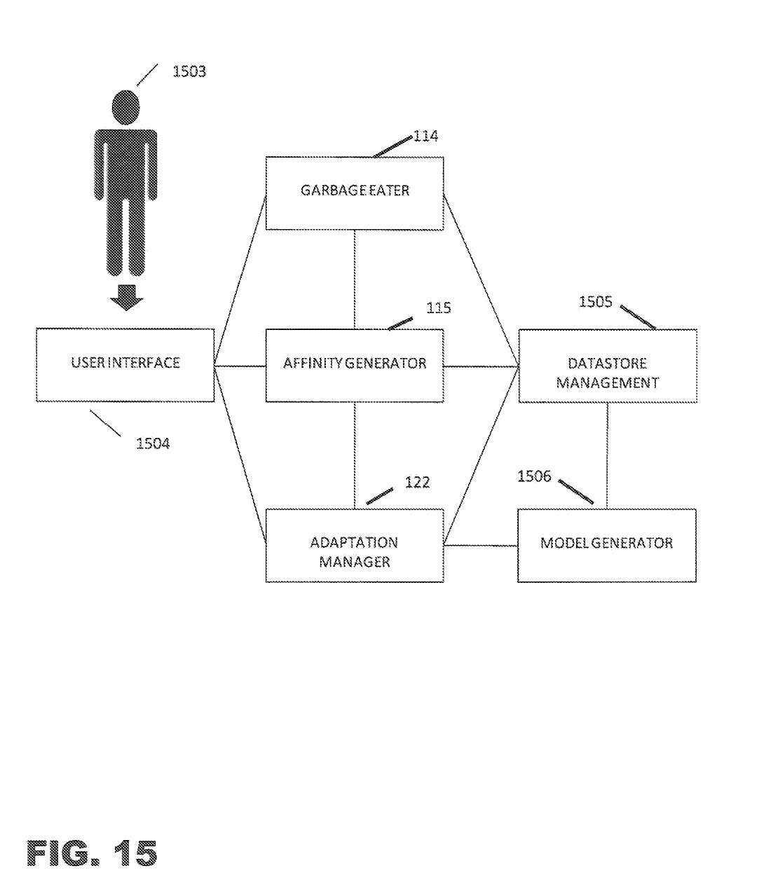

Turning now to FIG. 15, a high level block diagram of an auto-generation system 1400 according to the exemplary embodiment of the present invention is shown, illustrating five primary systems (modules). The auto-generation system 1400 comprises a simplified version of the auto-generation system 100 shown in FIG. 1. Each of the five modules is comprised of multiple subsystems, which are described in greater detail in relation to FIGS. 15-20. The five primary modules include a user interface 1504, a garbage eater 101, an affinity generator 115, an adaptation manager 111, a datastore management component 1505, and a model generator component 1506.

The user interface module 1504 handles all interactions between the system user 1501, end user 1502, or third party computer system 1503, and the network model generation system 1506. The user interface module 1504 includes subsystems for security and user authentication. The user interface module 1504 determines the format and the content to be presented external to the network model generation system 1506 and interprets inputs that are presented to that system.

The garbage eater 101 handles the parsing, disambiguation and tokenizing of all digital information 112 and network models 113 (See FIG. 1). The garbage eater parses and transforms digital information into a series of tokens and then disambiguates them. The affinity generator 115 handles the creation of all associations between tokens both within and across a specific information source. The affinity generator 115 executes one or more algorithms against the information tokens. The adaptation manager 111 handles the processing of context definitions, selection of neuro-cognitive models for a specific context, the execution of the models in the form of algorithms, and the training and optimization of algorithm compositions and configurations. The datastore manager 1505 handles the reading and writing of data including tokens, associations, weights, algorithms and neuro-cognitive models. The model generator 1506 extracts graph information and based on a specific template generates output in the appropriate format using transformation rules. Examples of output include generation of XML, OWL, or database schema.

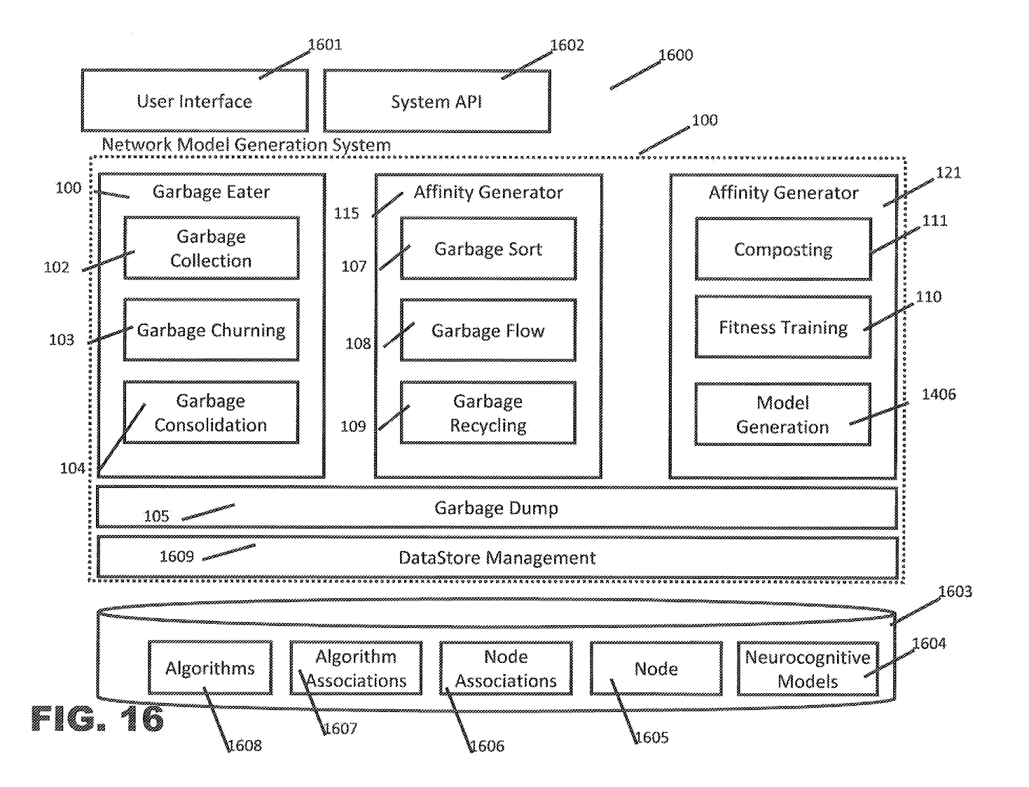

Turning now to FIG. 16, a detailed view in block diagram format of an auto-generation system 1600 according to an exemplary embodiment of the present invention is shown. The auto-generation system 1600 comprises a more detailed version of the auto-generation system 100 shown in FIG. 1. FIG. 16 shows the format of some of the various subsystems associated with the auto-generation system 100 shown in FIG. 1. Each functional block in FIG. 16 represents positions, modules, and components of the overall auto-generation system 100. Those skilled in the art will appreciate that various aspects of the present invention operate using a subset of the function blocks. Each function black will be described separately and then some the interactions of the blocks in implementing the various aspects of the present invention will be discussed.

The user interface 1601 is a conventional subsystem that provides the primary interface between the system 100 and users (not shown in FIG. 15). The user interface 1601 interacts with the user to receive commands and instructions and to provide results. The user interface 1601 operates, for example to generate code to display images and text, to arrange data into a format suitable for the intended recipient, to receive commands and to display messages. In an alternative embodiment, a system API 1602 may be replaced by a third party computer system which makes calls for reading and writing information from the system 100.

The garbage cater component 101 contains three subsystems: garbage collection 102, garbage churning 103, and garbage consolidation 104. Garbage collection 102 parses artifacts which consist of digital information 112 and network models 113 that are received from the user interface 1601 or a third party computer system through the system API 1602. Garbage collection parses the information, disambiguates the information and creates tokens for each artifact. Garbage churning 103 takes the tokens and creates associations between the tokens and the specific artifact, and between tokens and topics. Topics are non-explicit and latent sets of tokens that have been defined by the algorithms 601 that are defined in the neuro-cognitive models 121. Garbage consolidation 104 further processes the tokens and establishes relationships between the artifact specific tokens and other tokens and topics contained in individual ecosystems or all ecosystems. At this point the tokens and associations between tokens assume the structure of nodes and arcs in an n-dimensional graph (e.g., graph 1001 in FIG. 10).

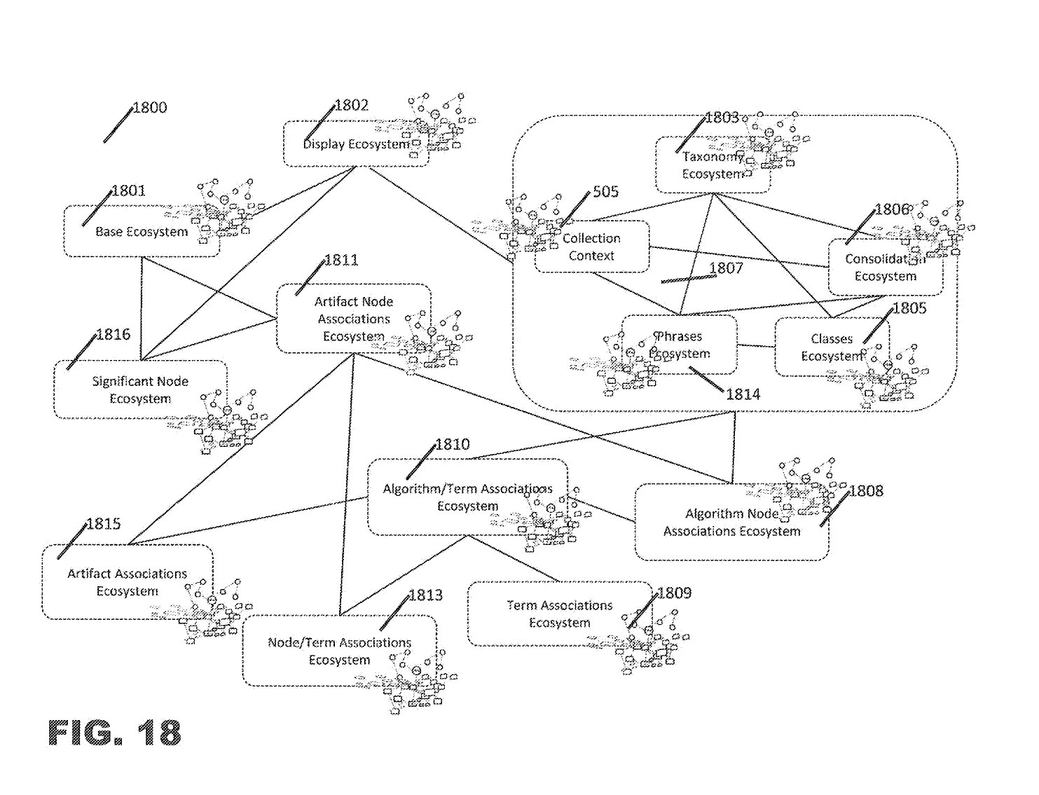

Following association generation, garbage dump 105 prepares the graph (e.g., graph 1001 in FIG. 10) for being written to the datastore 1603 through a data management interface 1609. The data management interface 1609 serves as the abstraction layer between the system 100 and the datastore 1603. The datastore 1603 is a fractally organized database that stores data as algorithms 1608, algorithm associations 1607, node associations 1606, nodes 1605, and neuro-cognitive models 1604. More detailed descriptions of the datastore and the specific organization of this data is provided in FIG. 18. In the present illustration, the datastore 1603 should be considered as a logical representation of data types rather than the actual physical storage.

Further graph processing occurs through the affinity generator component 115. The affinity generator component 115 consists of three subsystems: garbage sort 107, garbage flows 108, and garbage recycling 109. The garbage sort 107 subsystem uses one or more algorithms to identify graph dimensions. As previously discussed, the graph contains a number of topological structures that represent graph dimensions. Algorithms are able to extract the dimensions using the nodes and associations topologies and then map each node to the specific dimensions. Garbage flow 108 uses user generated context (not shown in this figure) to identify dimensions that are relevant to the context and creates associations between the provided context 119 and the dimensions. A specific context 119 is able to associate multiple dimensions and subsequent nodes. Garbage recycling 109 uses algorithm compositions based 605 to classify nodes across the multiple associated dimensions and determine the algorithms that best fit the resultant node collection.

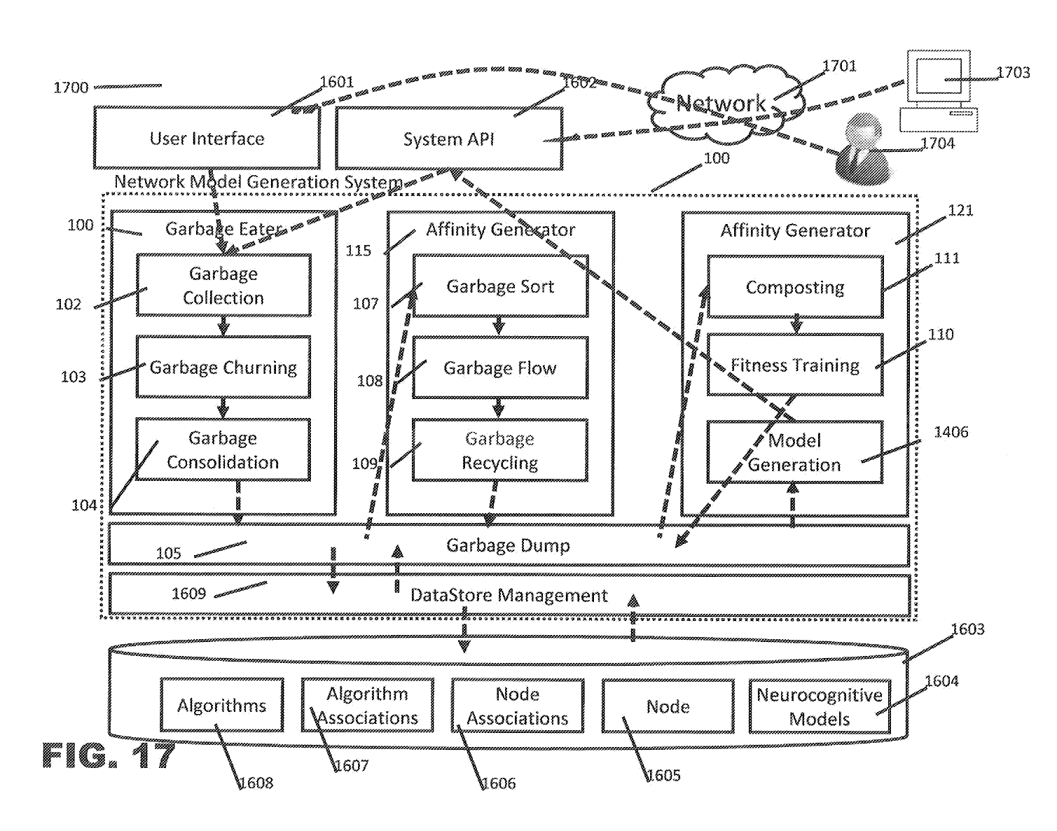

After node analysis, the final component the adaptation manager 121 is implemented. It consists of three subsystems: composting 111, fitness training 110, and model generation 1406. The composting subsystem 111 generates a result set based on a specific result set pattern. Users 1702 (not shown in this FIG. 16, but shown in FIG. 17) or third party computer systems 1703 (not shown in this FIG. 16, but shown in FIG. 17) provide feedback and train algorithms to optimize the result set. If the results do not meet minimal thresholds then the affinity management component 115 is called and each sub-system is re-executed. Finally, model generation 1406 uses a set of one or templates and rules to take an extracted graph data set and transform the data into a format that is usable by a third-party computer system 1703.

Turning now to FIG. 17, a detailed view in block diagram format of an auto-generation system 1700 according to an exemplary embodiment of the present invention is shown. The auto-generation system 1700 comprises a more detailed version of the auto-generation system 1600 shown in FIG. 16. Each functional block in FIG. 17 represents portions, modules, and components of the overall auto-generation system 100. FIG. 17 further includes communication flow lines between the various components illustrated. It should be further understood that the components and modules illustrated in FIG. 17 may be implemented as computer program software modules or routines that execute on a computer system that is provided for carrying out the tasks of the auto-generation system 100 as described herein. Those skilled in the art will understand that the exemplary method for carrying out many, if not all, of the functional tasks provided for in the disclosed system may be implemented as computer software running in a network environment with a physical architecture of multiple computer processors configured to operate with a conventional computer operating system, and/or may be deployed on an application server. Unless stated otherwise, components identified in FIG. 17, which have the same name (hut different reference numerals) as components previously identified in FIGS. 1-16, are intended to have the same or similar characteristics to the comparable components in such previous FIGS. 1-16.

As stated previously, most functional access to the system 100 occurs externally through a user interface 1601 and a user 1702, or a system API 1703 and a third party computer system 1703. A user 1702 loads digital information 112 or network models 113 for processing through the user interface 1601. Systems 1703 can also load digital information 112 or network models 113 for processing through the user interface 1602. The information is then parsed, disambiguated and tokens are created. Associations are then created with the tokens resulting in a graph using algorithms that extract and define explicit and latent groups of tokens 103. Further connections are made between the processed information and new graph with existing graphs 104 within the datastore 106. These associations 1607 are written to the datastore 106.

Algorithms are executed to further abstract dimensions using both explicit and latent dimensions 107. A user 1702 may also provide contextual information and events that results in extraction of specific graphs and the organizing of this information based on context and event attributes 108. Specific neuro-cognitive models 1604 which define algorithm compositions are then executed against the graphs 109. The result set is analyzed by a user 124 or system (not shown in the FIG. 17) and the algorithms are trained or tuned using evolutionary algorithms to maximize the best fit and optimized solution set. Associations are then recalibrated and weights adjusted and rewritten to the database 106.

FIG. 18 provides an illustration of the structure of the datastore 1603. The datastore 1603, in an exemplary embodiment of the present invention, is organized as an n-dimensional graph 1800. Each labeled node in the graph 1800 represents a singular dimension which in turn is composed of multiple scalable sub-graphs. Thus, one should consider each node as comprising a set of nest sub-graphs. In the present illustration each node is displayed as having only a single association, it should be further understood that across the nested sub-graphs there are multiple associations that are not displayed but are either explicitly defined or evident through latent analysis. For the purposes of providing a simplified illustration, these associations are not shown.

For those familiar with the state of the art, it should be evident that the underlying graph structure and data organization exhibits the self-similarity of a fractal mathematical organization. It should also be evident for those familiar with the state of the art, that the underlying graph structure exhibits certain topological structures expected for scale free networks. That is, the underlying topological structure exhibits preferential attention, hyper-connected node structures and small world characteristics.

Sub-graphs 1801 contain associations in a context. For example, sub-graph 1801 displays products connected to those people in that context, and then the neuro-cognitive connections to those products. Sub-graph 1802 contains the theme nodes computed for a context, from which the associates are based. Sub-graph 1807 contains sub-graphs representing graphs computed at the global level for an ecosystem. These sub-graphs include nested sub-graphs containing key phrases 1814, classes 1805, consolidated terms and term clusters 1806, consolidated contexts 1804, and consolidated taxonomic relationships 1803. Sub-graph 1811 contains sub-graphs of artifact-node associations. Sub-graph 1816 contains sub-graphs represents most significant nodes per artifact. Sub-graph 1815 contains sub-graphs shows how an artifact is connected via fuzzy-logic classifiers to other areas of other artifacts. Sub-graph 1810 contains sub-graphs of composite algorithms (from classifiers) attached to nodes in an artifact. Sub-graph 1813 contains sub-graphs associations between artifacts at the term instance level. Sub-graph 1819 contains sub-graphs associations between terms at the set or class level. Sub-graph 1813 contains sub-graphs associations between nodes and terms. Sub-graph 1810 contains sub-graphs associations between algorithms and terms. Additional sub-graphs may be created to organize additional dimensions as required.

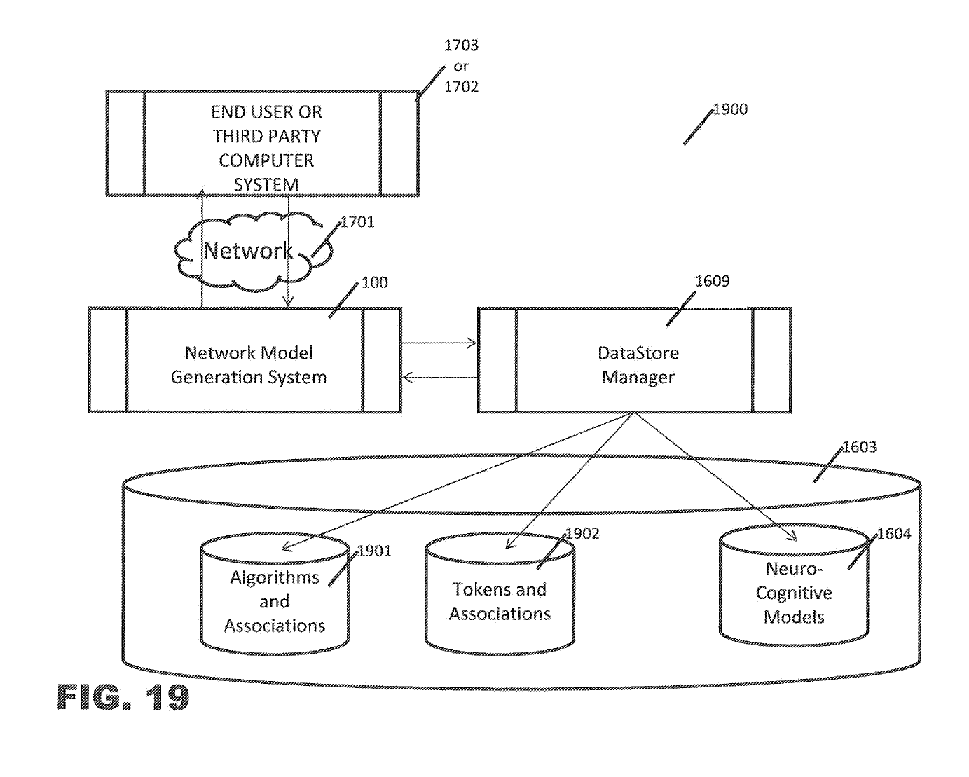

Turning now to FIG. 19, a block diagram illustrating a simplified, exemplary operating environment 1900 in which the system and methods of the present invention are used to read and write graphs from the datastore 1603. In this diagram, an end user, either a person 1703 or third party computer system 1702 interacts over a network 1701 with the network model generation system 100. Data, in the form of n-dimensional graphs are passed to or received from the datastore manager 1609 which then structures the sub-graphs for storage in various sub-stores expressed as algorithms and associations 1901, nodes and associations 1902, and neuro-cognitive models 1604. As expressly described in relation to FIG. 18, these sub-stores are logical representations of n-dimensional sub-graphs that have extensive associations within and across identified sub-graphs at the node level.

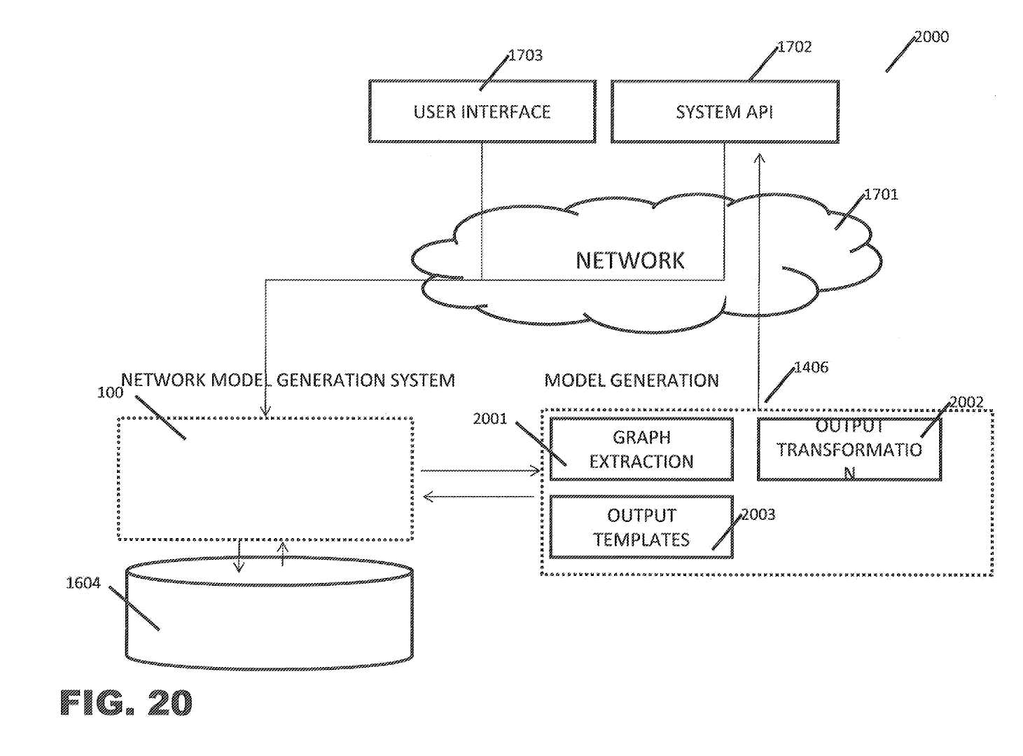

Turning now to FIG. 20, a block diagram illustrating a simplified, exemplary operating environment 2000 in which the system and methods of the present invention are used to produce output that is accessible through a system API 1702 by a third party system (not shown in FIG. 20). Examples of output, as previously described, include service descriptions such as web services, networked descriptions or directories of persons, products, processes, ontologies, taxonomies, schemas in the form of XML or database, and instance data for specific applications. In the operating environment 2000, a user (not shown in FIG. 20), interacts through a user interface 1703, or a third party computer system interactions with a system API 1702 across a network 1701, with the auto-generation system 100 and specifies the required output. The auto-generation system 100 reads and writes data to the datastore 1604. The model generation component 1406 extracts graph data from the datastore 1604. Model generation consists of three sub-systems: graph extraction 2001, output templates 2003, and output transformation operations 2002. Graph extraction 2001 contains the functions from extract the correct information from the graph data. Output templates 2003 contain the rules and algorithms for extracting correct data and the rules and algorithms for transforming the extracted data into the correct output. The output transformation operations 2002 executes data transformations to create the correct output structure based on the specified requirements. The output is then returned to the third party computer system (not shown in FIG. 20) through the system API 1702.

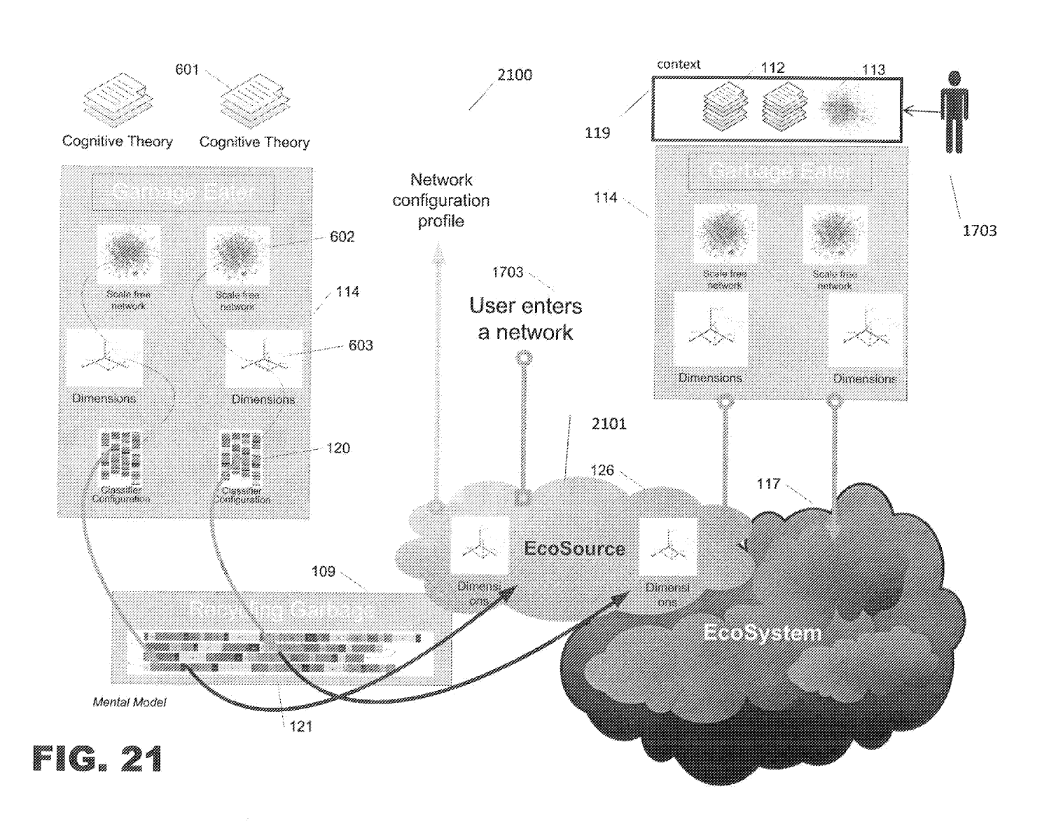

FIG. 21 is a high level schematic diagram of a system 2100 in which a user is accesses an ccosource 126. Recall that an ecosource 126 is a specific network model for a specific context 119 as extracted and optimized from an ecosystem 117 (See FIG. 1). First, one or more neuro-cognitive theories 601 are processed by garbage eater 114 resulting in specific scale free graphs 602. Subsequent processing identifies n-dimensions 603. The cognitive theory 601 is transformed into a neuro-cognitive model 121 through configuration of one or more algorithms 120 and using learning, feedback and genetic algorithms to create an optimized composition of algorithms representative of the cognitive theory. The result is the neuro-cognitive model 121.

Simultaneously, digital information 112 and network models 113 are processed by garbage eater 114 and a similar flow is followed of creating nodes and associations resulting in graphs 602 that are represented in n-dimensions 603 which forms the ecosystem 117. A user 1703 interacts with a system 2100, perhaps as a member of an online social network, and provides context information 119. This context information follows a similar process flow as above where nodes and associations are created resulting in graphs 602 that are represented in n-dimensions 603 as extractions from one or more existing ecosystems 117 forming the subset of information which is termed the ‘ecosource’ 2101. The ecosource 2101 consists of a model of networks of networks as contained in the ecosystem 117 as defined by the user's 1703 context 119. The neuro-cognitive models 121 as expressed in a series of algorithm compositions are then executed against the ecosource 2101 and the best fit and optimized set of algorithms return results 2102 that are then provided as a user profile output to the third party computer system (not shown in FIG. 21).

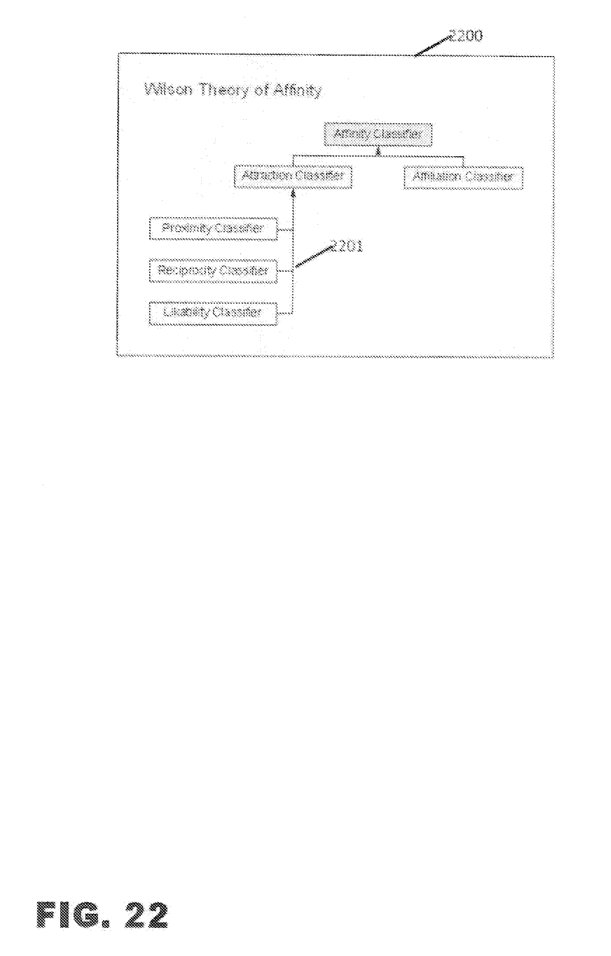

FIG. 22 is a high level block diagram of an illustrative example of how neuro-cognitive models are implemented into a set of algorithms 2200. In the exemplary embodiment shown, a specific theoretical model is implemented in the system 2200 through the implementation of specific classifier algorithms 601. Distinct elements of the theory are defined as classifiers. Optimization techniques, previously discussed, are used to optimize the various algorithms both as specific embodiment of the theoretical model or as an optimization across theories or neuro-cognitive models.

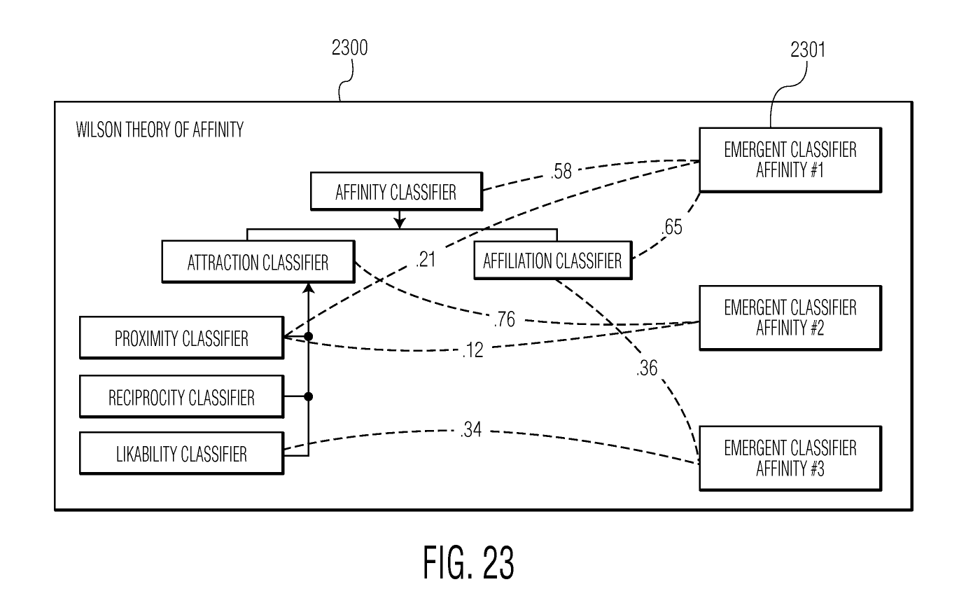

FIG. 23 is a high level block diagram of a classification system 2300. In the exemplary embodiment shown, the system 2200 relates to a cognitive theory 601 broken into a set of distinct classifier algorithms 2201. FIG. 23 illustrates in the exemplary embodiment of the invention, algorithms that compete for best fit and although through training, feedback and optimization for new algorithm compositions to emerge. These latent or emergent algorithms 2301 that result from the algorithm emergence are also shown.

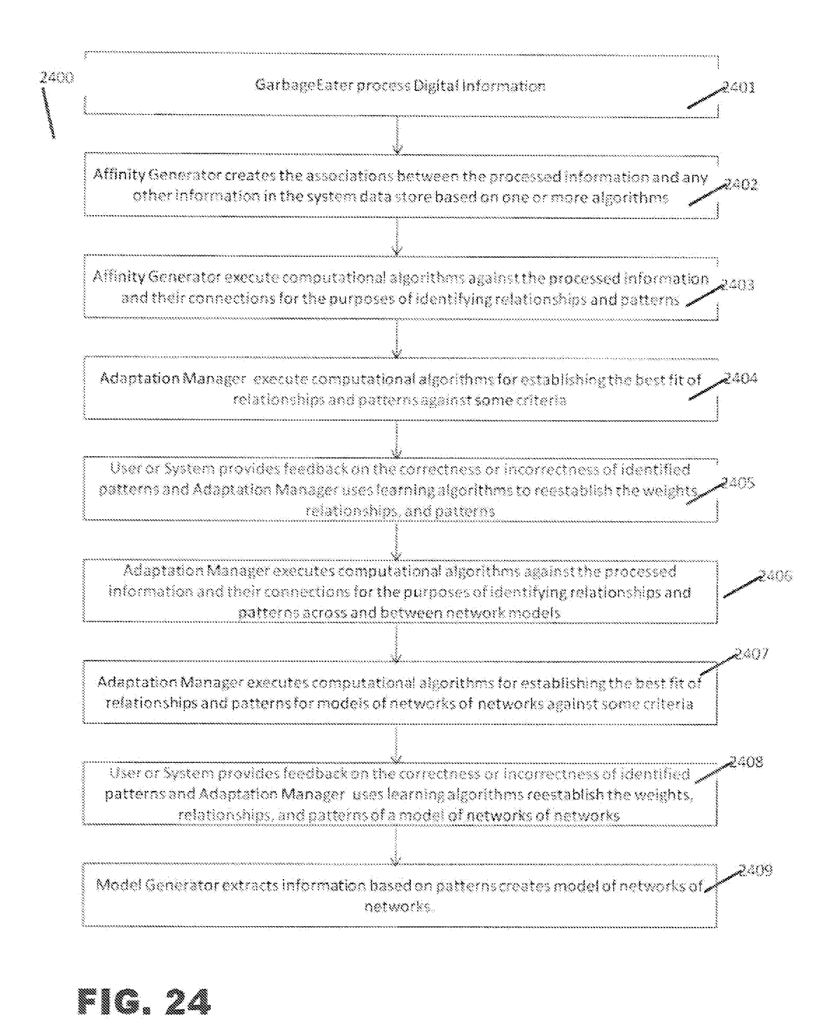

FIG. 24 is a flow chart illustrating a model generation process 2400 according to an exemplary embodiment of the present invention. A model may be generated by the processing of information, creating associations, and then training algorithms 603 based on a neuro-cognitive model 606 to create an optimal model of the network (See FIG. 6). The flow typically is initiated by the processing of information by the garbage cater 101 (Step 2401). This is generally performed and passed through the presentation layer. The affinity generator component 115 establishes the connections between the processed information and any other information in the system datastore based on one or more algorithms and describes those connections across n number of dimensions (Step 2402). The affinity generator component 115 executes computational algorithms against the tokens and their connections for the purposes of identifying relationships and patterns for the specific network, establishes the weights of the connections between processed information (Step 2403), and establishes the best fit of relationships and patterns against some criteria (Step 2404). User 1704 or system 1703 provides feedback on the correctness or incorrectness of identified patterns and adaptation manager component 121 uses learning algorithms to reestablish the weights, relationships, and patterns (Step 2405). Adaptation manager component 121 executes computational algorithms against the processed information and their connections for the purposes of identifying relationships and patterns across and between network models (Step 2406). Adaptation manager component 121 executes computational algorithms for establishing the best fit of relationships and patterns for models of networks of networks against some criteria (Step 2407). User 1704 or system 1703 provides feedback on the correctness or incorrectness of identified patterns and adaptation manager component 121 uses learning algorithms reestablish the weights, relationships, and patterns of a model of networks of networks (Step 2408). Model generator component 1406 extracts information based on patterns creates model of networks of networks (Step 2408).

Specific Discussion Example to Illustrate Further Aspects of the Invention

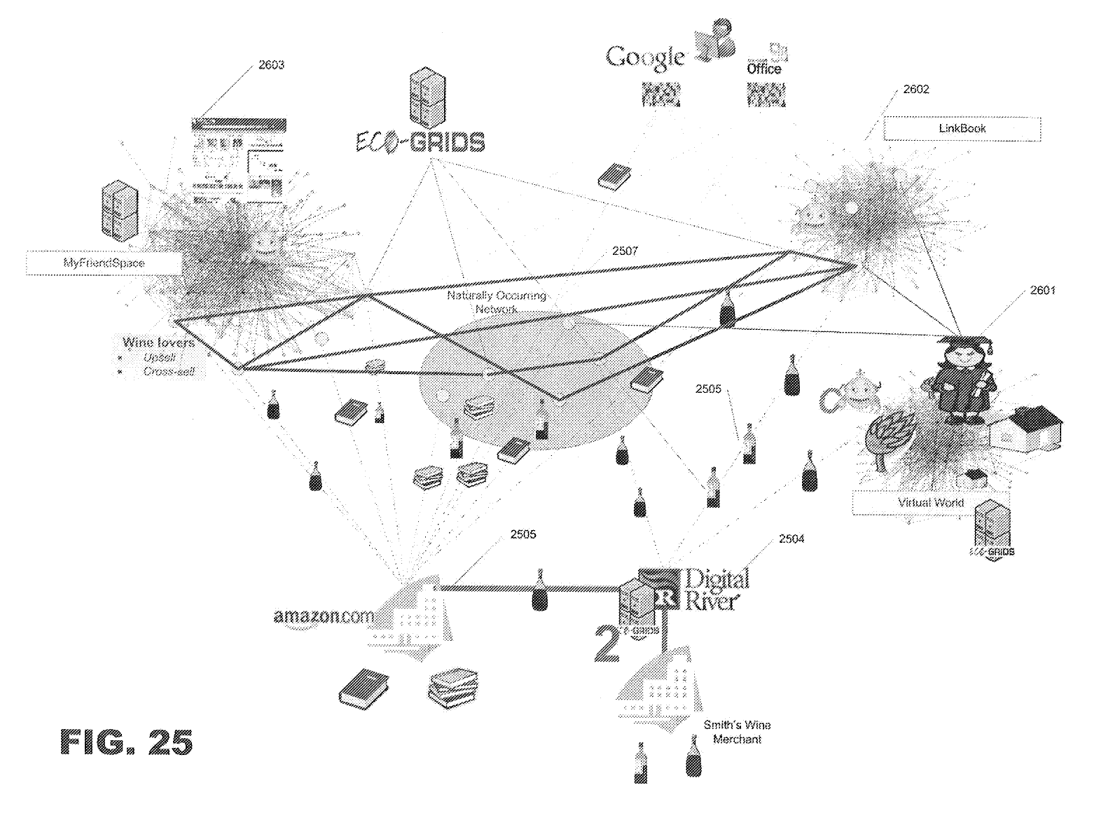

FIGS. 25-37 illustrate a specific example of how the system and methods of the present invention may be used in a powerful and practical way. In the present example, an exemplary embodiment of the invention is used to extract a model of networks within a single social network and then across social networks. Social networks are online applications allowing communities of individuals to emergence and share content in order to build community (e.g., Facebook®, Twitter®, etc.). Turning first to FIG. 25, it will become apparent that, like FIG. 1, FIG. 25 provides an overview of an auto-generation system 100. The illustration shows three social networks 2501, 2502, and 2503 each representing a different type of network including social collaboration applications, blogs and virtual worlds, respectively. The illustration also shows two sample ecommerce vendors 2504 and 2505. The auto-generation system 100 processes information from each network and the product and service purchases by network members 2506. The present invention is able to create a latent set of relationships between persons across networks as displayed in 2507 based on product purchases, shared content and user profiles that are optimized for the specific products purchased and offered by vendors.

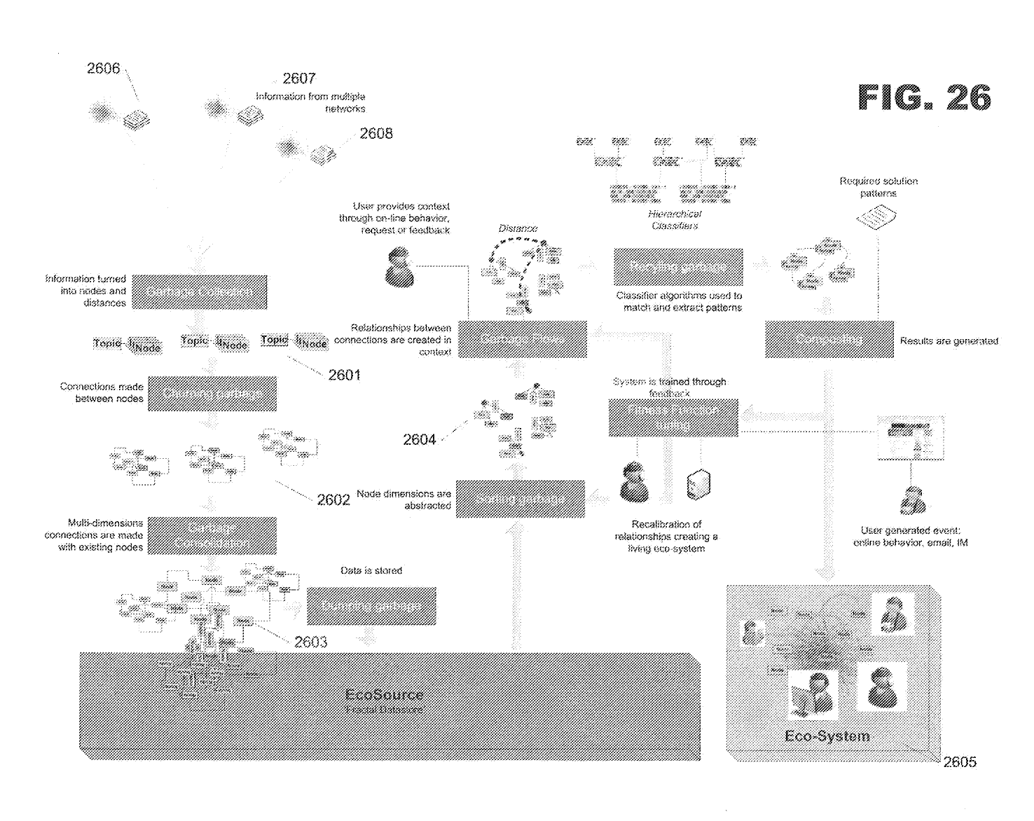

FIG. 26 is a further illustration of FIG. 25 and is similar to FIG. 1. This illustration shows network information being processed for each of the three social networks 2501, 2502, and 2503. Separate tokens are extracted and disambiguated for each network 2601. Independent graphs are created for each network 2602 and then consolidated with existing ecosystems 117 within the datastore 106. During the affinity generation processing 108 connections between networks graphs (i.e., networks 2501, 2502, and 2503, respectively) are created 2604 based on available context 119. Optimization occurs following the previously disclosed flow with the result between a network of network model as an output 2605 in the form of an eco-system 117.

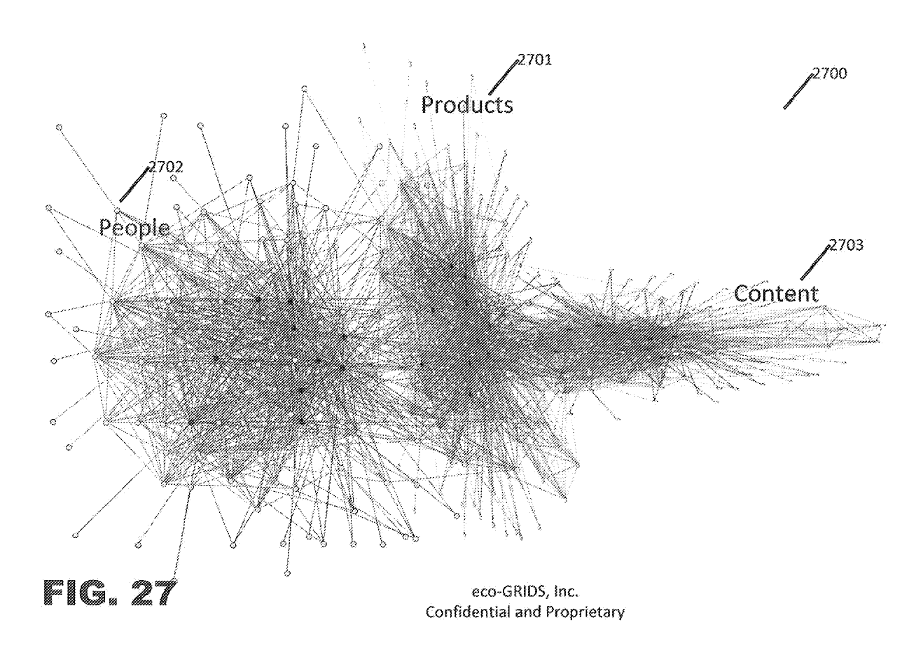

Turning to FIG. 27, an illustration 2700 is provided of a specific social network 2701. For the purposes of this illustration, assume that the social network is a network of fly fisherman. An individual social network is comprised of sub-networks, thus a ‘network of networks.’ Illustrated in FIG. 27 are networks, represented as graphs, of people 2703, content 2701, and product references 2702. Each of these smaller networks are graphs contain entities represented as nodes and associations between nodes with corresponding weights. These associations, as previously discussed, may be explicitly defined through the processing of digital information 112 or network models 113, or may be derived from the use of algorithms for identification of latent associations thereby allowing networks to emerge.

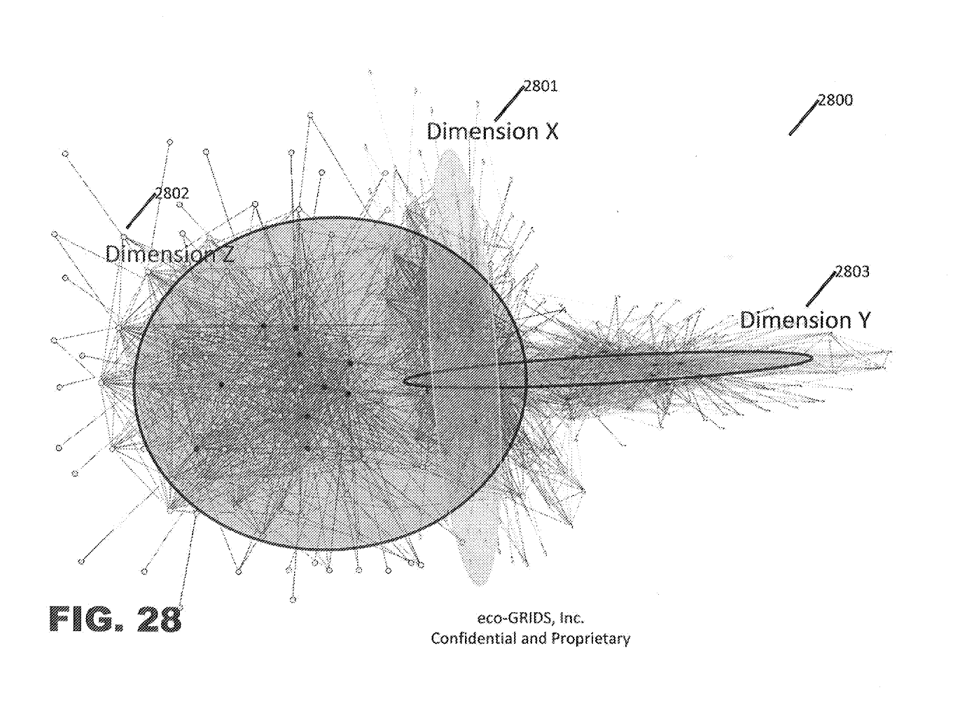

FIG. 28 is an extension of FIG. 27 and is an illustrative diagram 2800 of the inherent dimensions within these three networks (2701, 2702, and 2703, respectively). Illustrated in the present FIG. are three dimensions that correspond with each of the individual networks. This is shown as an example. In reality both explicit and latent associations will establish an n-dimensional representation of the three networks. This n-dimensional set of relationships across networks constitutes a network of network model of the fly fishing social network example.

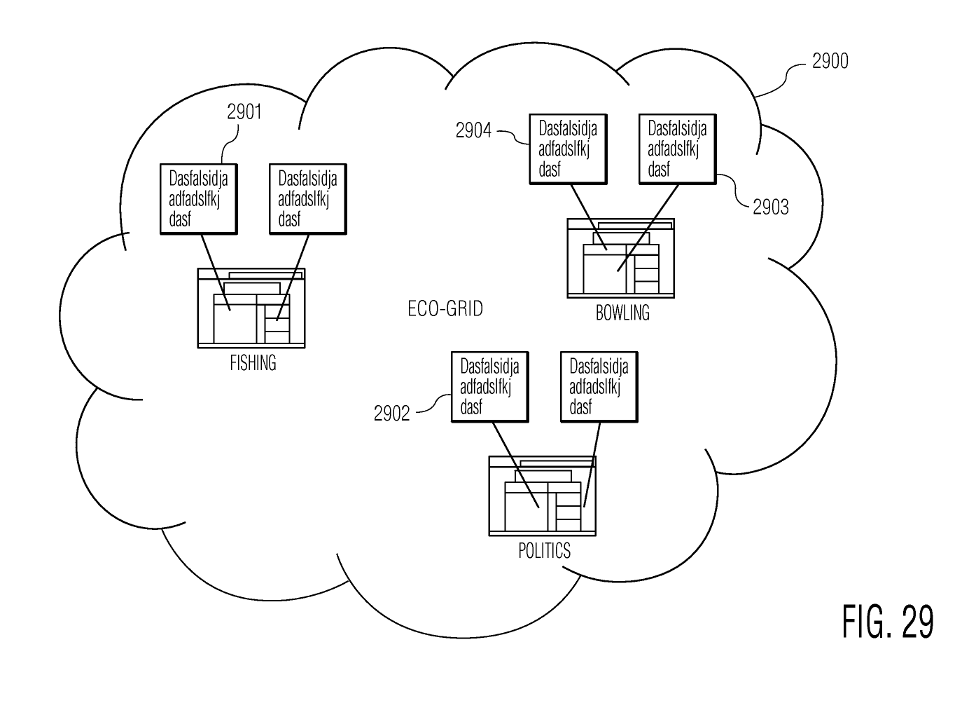

FIG. 29 is an extension of FIG. 27 and is an illustrative diagram 2900 of the process across multiple social networks. Three social networks are identified: Fishing enthusiasts 2901, political bloggers 2902, and bowling enthusiasts 2903. Each of these social networks contains content 2904.

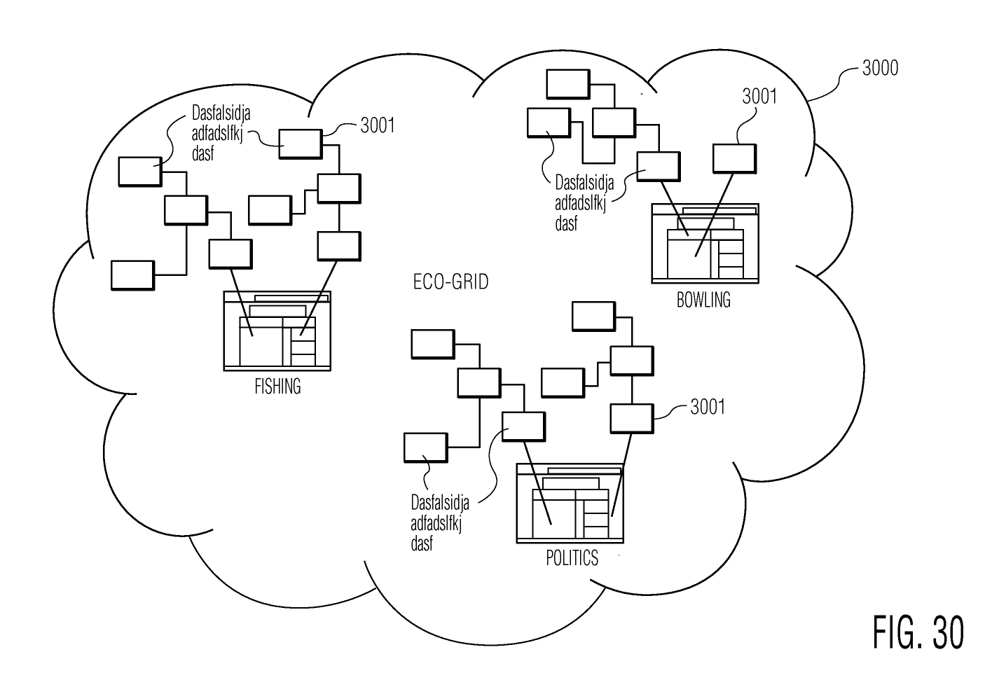

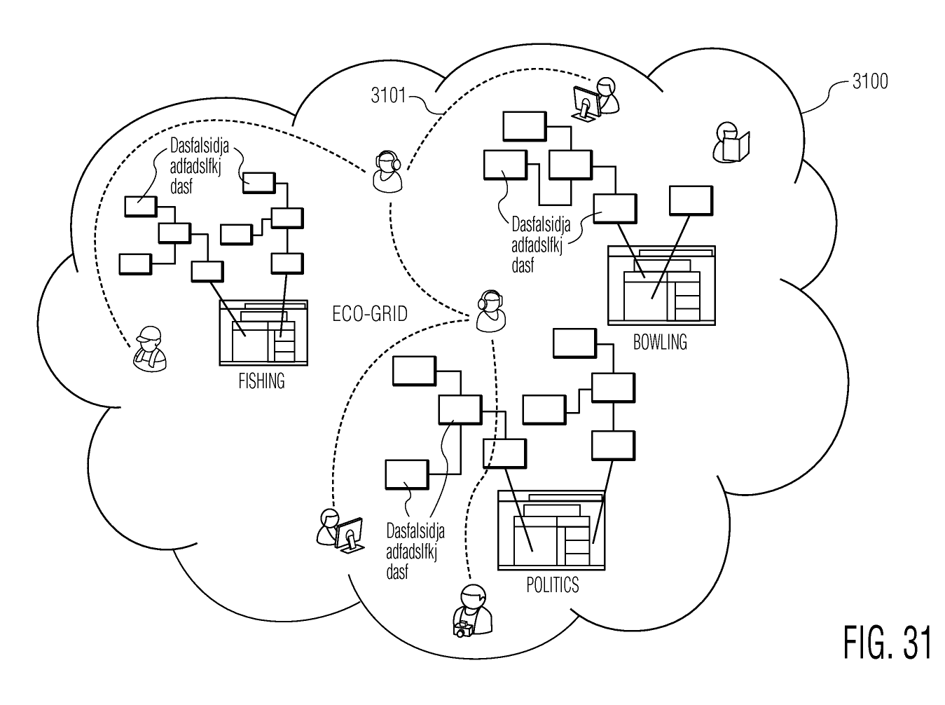

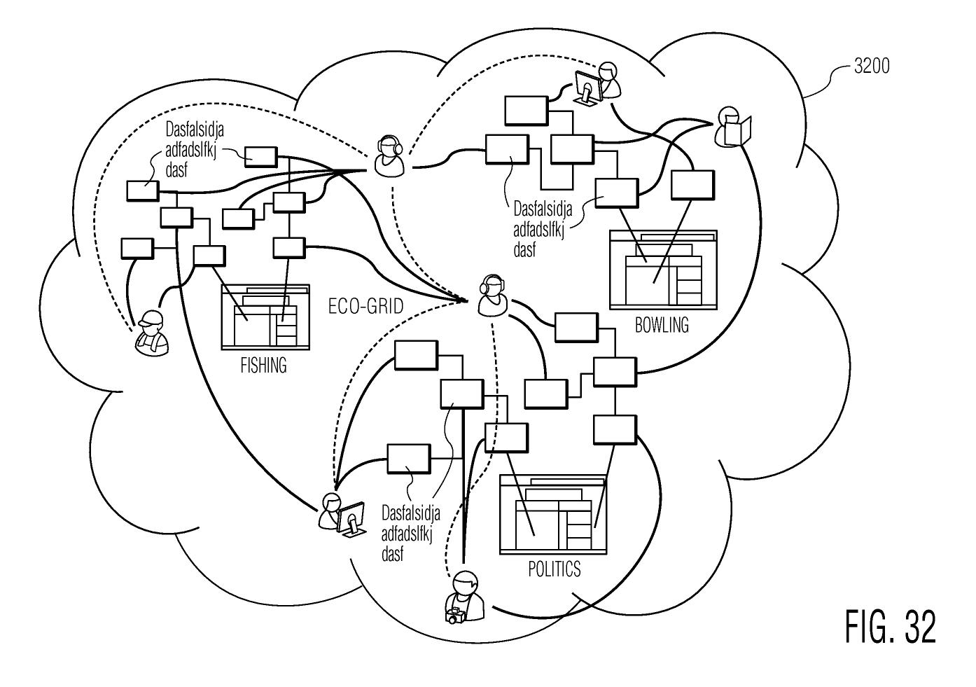

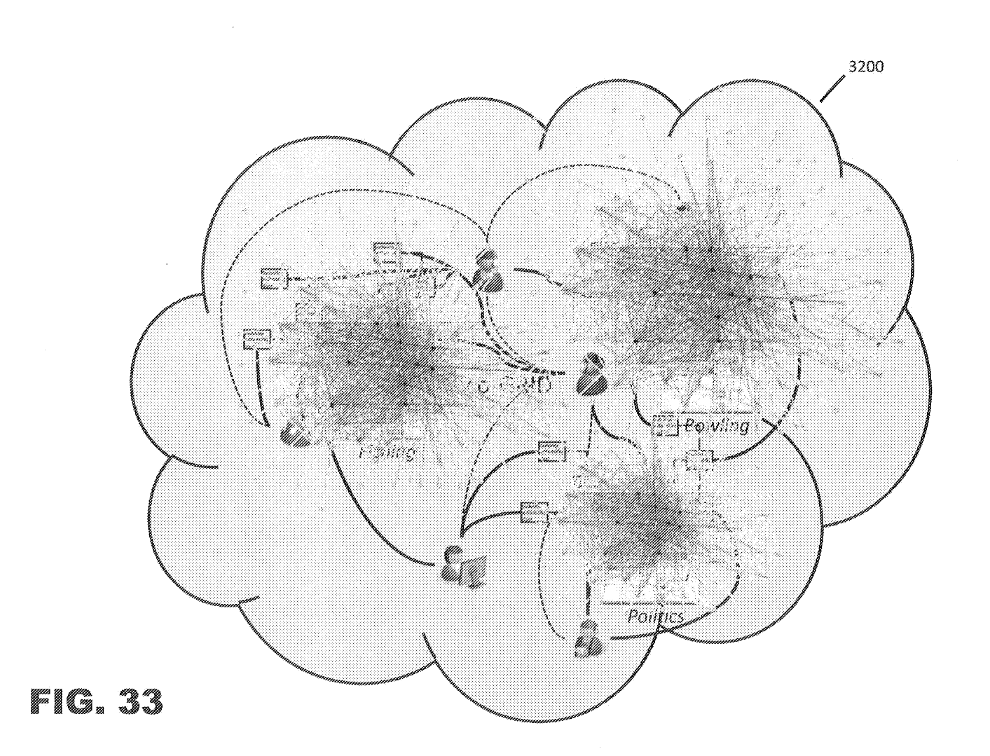

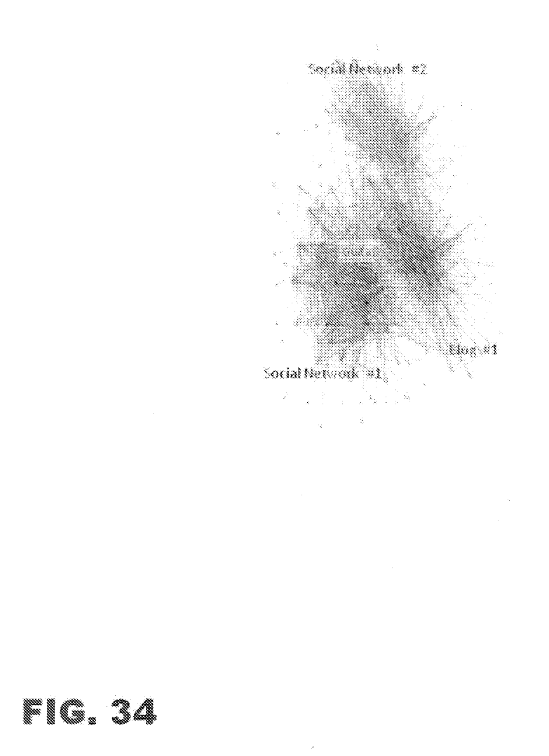

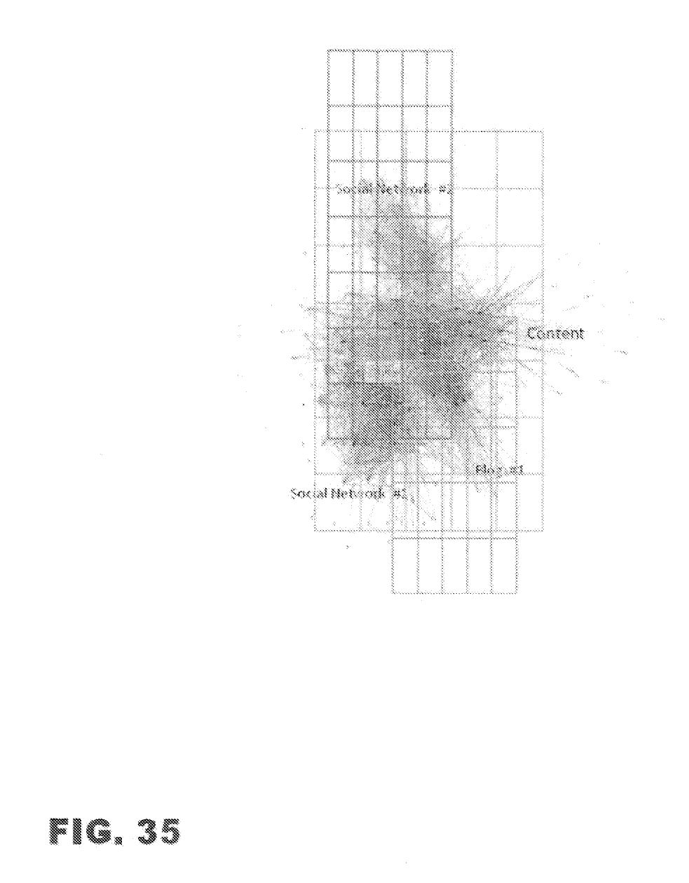

FIG. 30 illustrates the associations between content within each social network 3001. Each content artifact has an author. FIG. 31 illustrates the underlying social connections between social network members 3100. For example, two persons are shown to share membership or association 3101 in the bowling social network 2903. FIG. 32 illustrates the authorship of each content artifact and the connections between that content based on authorship. FIG. 33 illustrates the interconnections between persons and content with a specific social network 3300 which as discussed previously can be represented as an n-dimensional graph. FIG. 34 illustrates the interconnection of the three graphs from each social network suggesting additional associations and n-dimensionality 3400. FIG. 35 illustrates in the form of grids the multiple overlapping dimensions contained in the topological structures of these overlapping networks and their associations 3500.

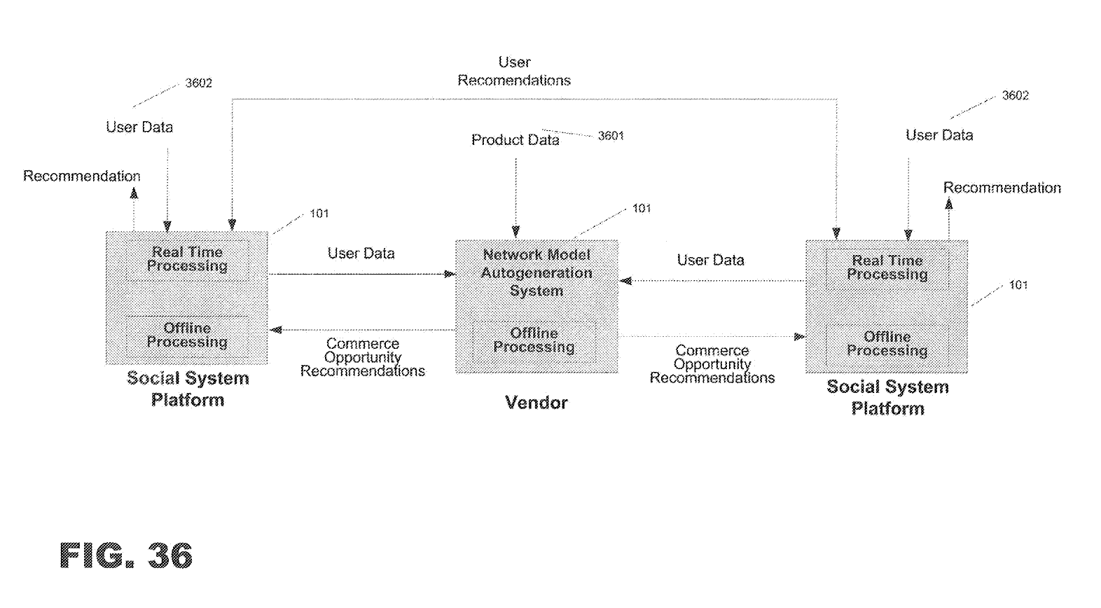

Turning now to FIG. 36, a block diagram showing an auto-generation system 100′ according to an exemplary embodiment of the present invention is illustrated. Specifically, the auto-generation system 100′ receives product data including product descriptions and marketing messages 3601 directly from commerce providers and user data 3602 from social network third party computer systems 3603. Information flows are indicated between the system 100′ and the third party computer systems. User data is processed along with product data 3605 by the system 100 and then product recommendations and messages 3604 are returned.

FIG. 36 illustrates the ability to identify and combine networks for processing, selecting a neuro-cognitive model for execution, processing the networks, and generating the results.

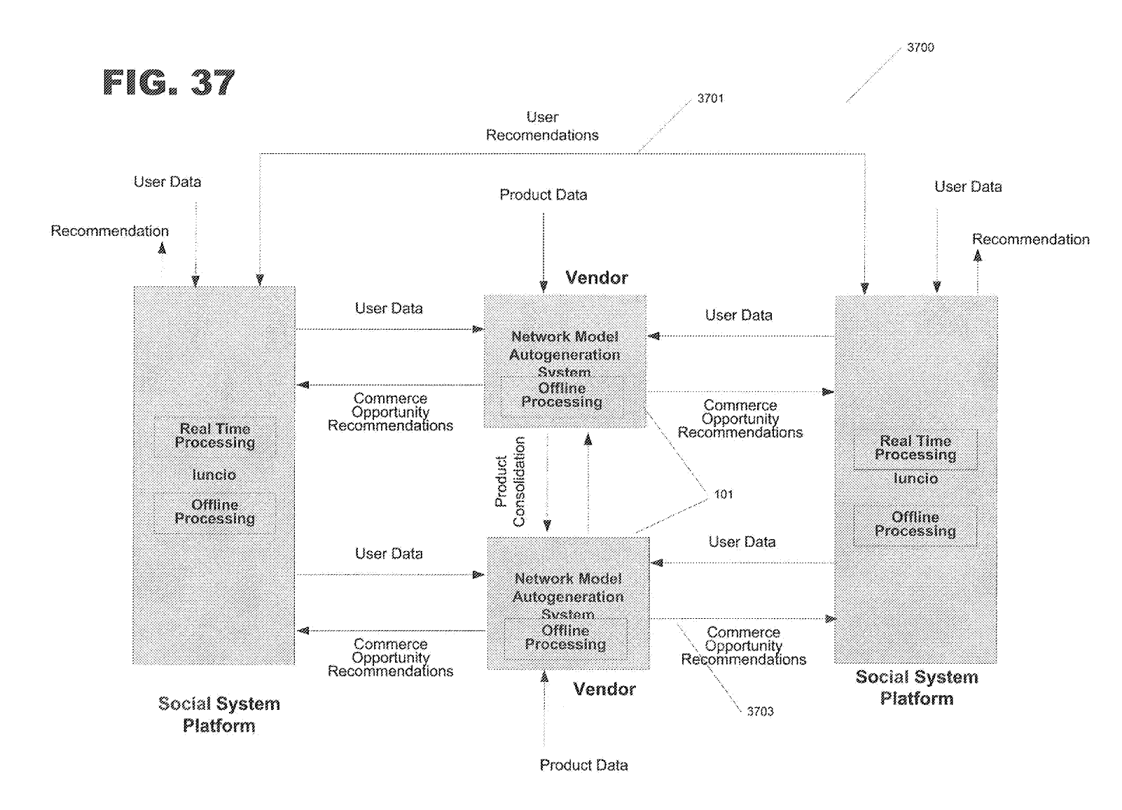

FIG. 37 is a block diagram showing an auto-generation system 100″ according to another exemplary embodiment of the present invention. Specifically, the auto-generation system 100″ receives product data including product descriptions and marketing messages 3601 and user data 3702 through a direct connection with a commerce vendor 3701 as well as user data 3602 from social network third party computer systems 3603. Multiple product data sources are represented 3703. Information flows are indicated between the system 100″ and the third party computer systems (3603 and 3701, respectively). User data is processed along with product data 3605 by the system 100 and then product recommendations and messages 3604 are returned.

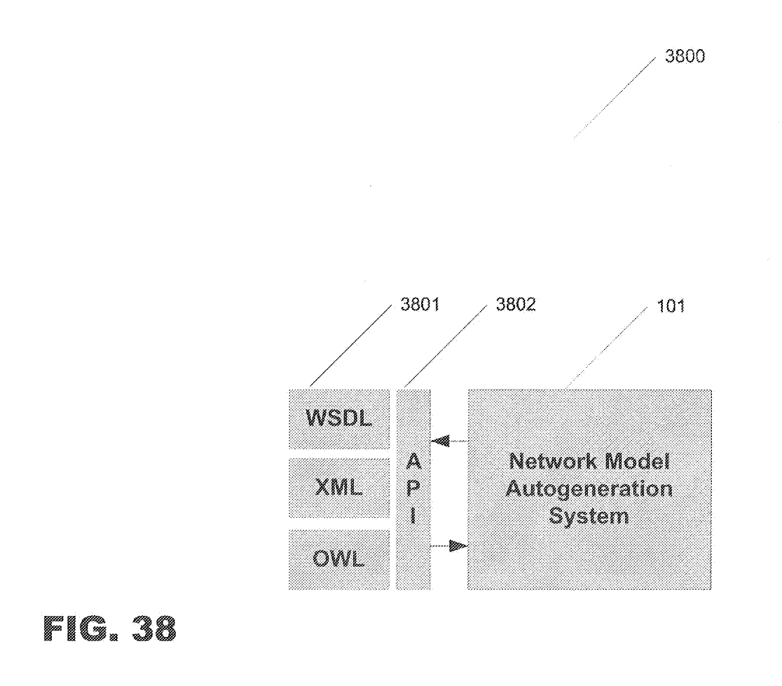

Turning now to FIG. 38, sequence diagrams illustrating the various communications between the computer programs and modules of FIG. 1 are illustrated. It will be understood and appreciated by those skilled in the art that the sequence diagrams further illustrate the various inputs that trigger the processes, the various software components or modules that re executed to carry out specific computing tasks, and the results that are returned to reflect the execution of the specific sub-processes described in the individual figures. Those skilled in the relevant art will understand how to write computer program code to carry out the methods and functions of the various components shown in FIG. 1 by following the temporal sequence of these FIG. 38. It should be understood that, for these FIG. 38, time “begins” in the upper left hand corner of the diagram and extends downwardly, while the various computer program or components that are executed and the sequence in which such components executed carry across the lop of the diagram.

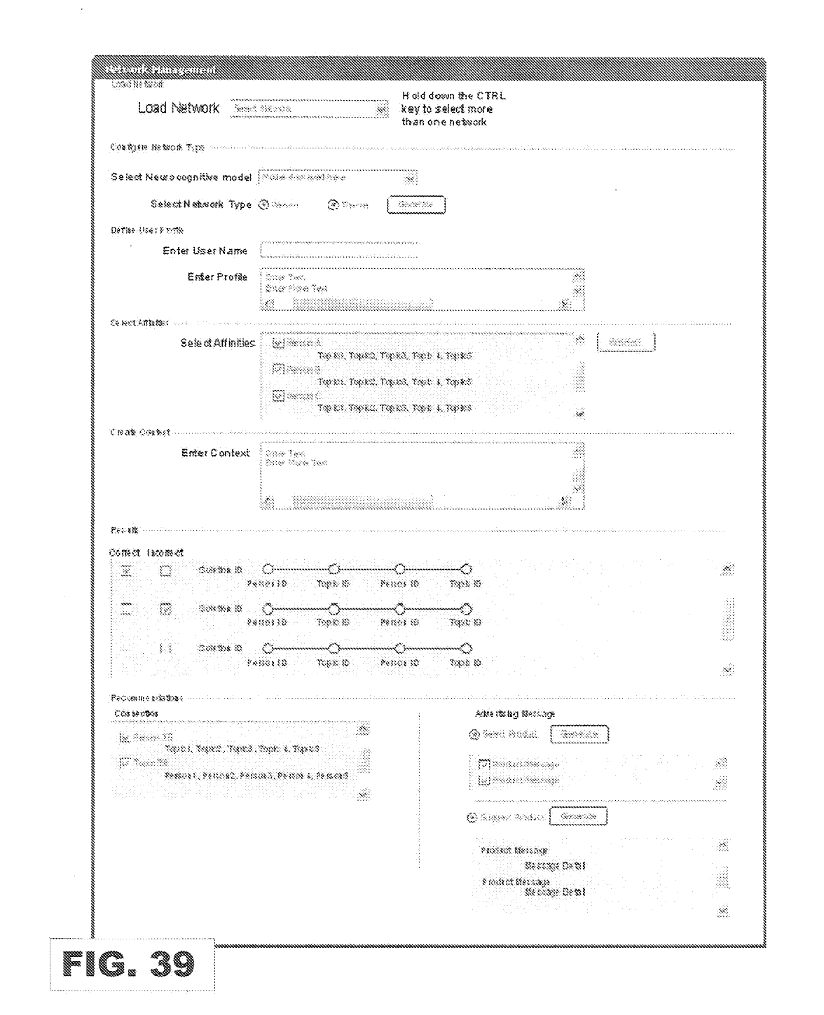

FIG. 39 is an example of particular user interface screens and graphical user interface (GUI) components that are provided in the described and disclosed embodiments of the present invention. Those skilled in the art will understand and appreciate that these user interface screens can take various forms and layouts and can be implemented with various input devices, such as keyboard, mouse, push button, voice activation, or other user input devices and can display appropriate information in various forms, such as display screens, printouts, audible announcements, tactile feedback, and other forms of communication of information to a human. In like manner, although the following user interface screens are providing connection with a human interface, it will of course be appreciated that many aspects of the present invention can be implemented by computer-to-computer communications wherein input information is provided automatically in a predetermined format, with output provided in return in a predetermined format, with no intervening displays to a human being to provide a totally-automated operation on a computer-to-computer basis. It will thus be understood that the following description relates solely to interactions of a human being with the computer system, typically while an end user's computer system 1703 or a system user's computer system 1702 accesses the system of the present invention (See FIG. 17).

The GUI shown in FIG. 39 is merely an example, and those skilled in the art will understand and appreciate that information and format and content displayed in each of these screen may likewise be displayed in many different manners and that no limitations are intended by the particular display shown in connection with FIG. 39.

In view of the foregoing detailed description of exemplary embodiments of the present invention, it readily will be understood by those persons skilled in the art that the present invention is susceptible to broad utility and application. While various aspects have been described in the context of standalone application, the aspects may be useful in other contexts as well. Many embodiments and adaptations of the present invention other than those herein described, as well as many variations, modifications, and equivalent arrangements, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a exemplary sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to exemplary embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

What is claimed is:

1. A computer system comprising:
at least one server computer; and,
at least one client computer coupled to the at least one server computer through a network;
wherein the at least one server computer includes at least one program stored thereon, said at least one program being capable of performing the following steps:
processing information relating to at least one artifact;
establishing at least one relationship between the processed information and information contained in a first datastore;
establishing the degree to which the processed information and the at least one relationship conform to at least one predetermined pattern; and,
forming a network model based on the at least one relationship and the at least one predetermined pattern.

2. The computer system of claim 1, wherein said at least one program is capable of performing the further step of:
establishing one or more connection weights based on the at least one relationship, the at least one predetermined pattern, and at least one computational algorithm.

3. The computer system of claim 1, wherein said at least one relationship is measured across a plurality of dimensions.

4. The computer system of claim 2, wherein said at least one program is capable of performing the further steps of:
providing feedback regarding at least one of the one or more connection weights, the at least one relationship, and the at least one predetermine pattern;
altering one or more of the at least one connection weight, the at least one relationship, and the at least one predetermine pattern depending upon the feedback.

5. The computer system of claim 1, wherein said step of processing information relating to at least one artifact comprises:
parsing the information; and,
generating at least one token corresponding to the parsed information.

6. The computer system of claim 5, wherein said step of processing information relating to at least one artifact further comprises:
generating at least one n-gram for the at least one token; and,
creating at least one first association between the at least one token and another token using the at least one n-gram.

7. The computer system of claim 1, wherein said step of establishing at least one relationship between the processed information and information contained in a first datastore comprises:
creating at least one association between the processed information and information contained in the first datastore; and
storing information relating to the at least one association in the first datastore.

8. The computer system of claim 1, wherein said step of establishing the degree to which the processed information and the at least one relationship conform to at least one predetermined pattern comprises:
implementing one or more algorithms to determine the dimensions of an initial network model representing the processed information and the at least one relationship;
permitting a user to assert context information;
establishing one or more distances between nodes of the initial network model;
establishing one or more distances between dimensions of the initial network model; and,
determining the degree to which the initial network model conforms to at least one predetermined pattern, the predetermined pattern being stored in the first datastore.

9. The computer system of claim 1, wherein said step of establishing the degree to which the processed information and the at least one relationship conform to at least one predetermined pattern further comprises:
implementing at least one algorithm to determine the applicability of the initial network model;
measuring feedback; and,
modifying the at least one algorithm based on the feedback; and,
altering at least one connection weight within the initial network model based on the feedback.

10. The computer system of claim 1, wherein said step of processing information relating to at least one artifact comprises generating a plurality of tokens corresponding to the information processed.

11. The computer system of claim 10, wherein said step of establishing at least one relationship between the processed information and information contained in a first datastore comprises generating at least one relationship between one or more of the plurality of tokens, and a plurality of tokens stored in the first datastore.

12. The computer system of claim 11, wherein said step of establishing the degree to which the processed information and the at least one relationship conform to at least one predetermined pattern comprises generating a token graph representative of the plurality of tokens and the at least one relationship.

13. The computer system of claim 12, wherein said step of forming a network model based on the at least one relationship and the at least one predetermined pattern comprises associating the token graph with a specific context.

14. The computer system of claim 13, wherein said step of forming a network model based on the at least one relationship and the at least one predetermined pattern further comprises associating the token graph with an algorithm graph.

15. The computer system of claim 14, wherein algorithm graph is created by the steps of:
implementing a neuro-cognitive model comprised of a plurality of algorithms;
generating at least one relationship between the two or more of the plurality of algorithms: and,
generating an algorithm graph representative of the plurality of algorithms and the at least one relationship.

16. The computer system of claim 13, wherein said step of forming a network model based on the at least one relationship and the at least one predetermined pattern further comprises measuring changes in the token and algorithm graphs over time.

17. The computer system of claim 16, wherein said step of forming a network model based on the at least one relationship and the at least one predetermined pattern further comprises changing one or more weightings for the token graph or the algorithm graph based on the changes in the token and algorithm graphs over time, feedback information, or context information.

18. A computer system for auto-generation of network models comprising:
a processing component;
an affinity generation component;
an adaptation manager; and
a datastore.

19. The computer system of claim 18, wherein the processing component further comprises:
a garbage eater component;
a garbage churning component;
a garbage consolidation component; and
a garbage dumping component,
wherein information output from garbage dumping component is transmitted to the datastore.

20. The computer system of claim 18, wherein the processing component parses information and creates at least one token corresponding to the information.

21. The computer system of claim 20, wherein the processing component disambiguates the information.

22. The computer system of claim 18, wherein the affinity generation component executes at least one algorithm to establish at least one connection between the at least one token and one or more tokens in the datastore.

23. The computer system of claim 18, wherein the adaptation manager component executes at least one algorithm to establish at least one pattern.

24. A computer readable medium having embodied therein a computer program for processing by a machine, the computer program comprising:
a first code segment for processing information relating to at least one artifact;
a second code segment for establishing at least one relationship between the processed information and information contained in a first datastore;
a third code segment for establishing the degree to which the processed information and the at least one relationship conform to at least one predetermined pattern; and,
a fourth code segment for forming a network model based on the at least one relationship and the at least one predetermined pattern.
